(19) United States
(12) Patent Application Publication
(10) Pub. No.: US 2005/0233086 A1
(43) Pub. Date: Oct. 20, 2005

(54) Method of producing a shaped article having excellent barrier properties

(75) Inventors: Hong-Ta James Chan, Pasadena, TX (US); Tomoyuki Watanabe, Pasadena, TX (US); William Scott Lambert, Pasadena, TX (US); Nahoto Hayashi, Kurashiki-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KURARAY CO., LTD, Kurashiki-City (JP)

(21) Appl. No.: 11/144,766

(22) Filed: Jun. 6, 2005

Related U.S. Application Data
(62) Division of application No. 09/608,011, filed on Jun. 30, 2000.

(51) Int. Cl. B05D 1/08; B05D 1/36; B05D 7/00; H05H 1/26; C23C 4/00

(52) U.S. Cl. 427/402; 427/446

(57) ABSTRACT

A powder of a barrier material (B) is, after having been melted, applied to a substrate of a polyolefin (A) to give a shaped article, in which the barrier material (B) firmly adheres to the polyolefin (A) even when the surface of the substrate is not subjected to primer treatment. The shaped article is favorable to components to fuel containers, fuel tanks for automobiles, fuel pipes, etc.

### BACKGROUND OF THE INVENTION

1. Field of the Invention

The present invention relates to a method of producing a shaped article, which comprises applying a powder of a barrier material, after melting it, to a shaped article of a polyolefin. The invention also relates to a shaped article produced by applying a powder of a barrier material (B), after melting it, to at least a part of the surface of a substrate of a polyolefin (A).

2. Description of the Background

Polyolefin is a resin having good water resistance, mechanical strength and moldability, and is molded in melt into various shapes of films, bottles and others of many applications. On the other hand, for making shaped articles of such polyolefin have barrier properties and oil resistance, preferred are embodiments of multi-layered shaped articles which comprises a polyolefin layer and a barrier material layer. However, barrier materials of typically ethylene-vinyl alcohol copolymer (hereinafter referred to as EVOH) and others are not all the time satisfactorily adhesive to polyolefin, and the multi-layered shaped articles often undergo interlayer peeling between the polyolefin layer and the barrier layer.

To solve the problem, various types of adhesive resins have been developed, including maleic anhydride-modified polyolefins (polyethylene, polypropylene, ethylene-vinyl acetate copolymers), ethylene-ethyl acrylate-maleic anhydride copolymers, etc. With these adhesive resins, multi-layered shaped articles of polyolefin and a barrier material are formed through co-extrusion or the like, in which the polyolefin substrate is laminated with the barrier material via the adhesive resin therebetween, and they have many applications.

However, there is a problem in using adhesive resins as above, since it is required an additional step in the production process and therefore increase the production costs. For complicated shapes, preferred is injection molding. However, it is not easy to mold multi-layered shapes by injection. It is often difficult to obtain injection-molded multi-layer articles of polyolefin laminated with a barrier material via an adhesive resin therebetween, and the shape of such injection-molded multi-layer articles is often limited.

For making such complicated shapes have barrier properties, known is one method of coating the shapes with a solution of a barrier material. One example of the method is disclosed in Japanese Patent Laid-Open No. 64519/1982, in which the technique disclosed comprises forming a layer of a solution of EVOH dissolved in a mixed solvent of alcohol-water, on a substrate, followed by drying it to form a film thereon. In general, however, the method often requires complicated primer treatment and even adhesive treatment for ensuring sufficient interlayer adhesion strength between the substrate and EVOH, therefore resulting in the increase in the production costs.

Japanese Patent Laid-Open No. 115472/1991 discloses a powdery coating resin of EVOH, and plastics are referred to therein as one example of the substrates to be coated with the powdery coating resin. However, the laid-open specification says nothing about a technique of applying the powdery coating resin of EVOH to polyolefins.

Co-extrusion blow-molded plastic containers are favorably used these days for storing therein various types of fuel such as gasoline. One example is a fuel tank for automobiles. For the plastic material for such containers, polyethylene (especially very-high-density polyethylene) is expected as being inexpensive and having good moldability and workability and good mechanical strength. However, polyethylene fuel tanks are known to have a drawback in that vapor or liquid of gasoline stored therein readily evaporates away in air through the polyethylene wall of the containers.

To overcome the drawback, disclosed is a method of applying a stream of halogen gas (fluorine, chlorine, bromine), sulfur trioxide (SO₃) or the like into polyethylene containers to thereby halogenate or sulfonate the inner surface of the containers. Also disclosed is a method of forming a multi-layered structure of polyamide resin and polyethylene resin (Japanese Patent Laid-Open No. 134947/1994, U.S. Pat. No. 5,441,781). Apart from these, known is a method of forming a multi-layered structure of EVOH resin and polyethylene resin (U.S. Pat. No. 5,849,376, EP 759,359). For improving its gasoline barrier properties, known is a multi-layered fuel tank in which the barrier layer is shifted to the inner layer (Japanese Patent Laid-Open No. 29904/1997, EP 742,096).

However, the fuel containers produced according to the above-mentioned methods are not as yet all the time satisfactory for preventing gasoline permeation through them. The recent tendency in the art is toward gasoline saving and global environment protection, for which is therefore desired a method of further reducing gasoline permeation through fuel tanks.

As in the above, it is desired to develop a method of producing shaped articles having excellent barrier properties, which is applicable even to complicated shapes of a polyolefin substrate without requiring any complicated primer treatment. Of such shaped articles having excellent barrier properties, more desired are those having a multi-layered structure of polyolefin and a barrier material and effective for preventing gasoline permeation therethrough.

### SUMMARY OF THE INVENTION

The present invention is to provide a method of producing shaped articles having excellent barrier properties, which is applicable even to complicated shapes of a polyolefin substrate without requiring any complicated primer treatment. Specifically, the invention is a method of producing a shaped article, which comprises applying a powder of a barrier material (B), after melting it, to a substrate of a polyolefin (A). The invention also relates to a shaped article produced by applying a powder of a barrier material (B), after melting it, to at least a part of the surface of a substrate of a polyolefin (A).

In one preferred embodiment of the method of the invention, the step of applying the powder of a barrier material (B), after melting it, to the substrate of a polyolefin (A) is applied according to a flame spray coating process.

Another preferred embodiment of the method of producing a shaped article of the invention comprises applying a powder of a carboxylic acid-modified or boronic acid-modified polyolefin, after melting it, to a substrate of a polyolefin (A), followed by applying a powder of a barrier material (B), after melting it, to the resulting carboxylic acid-modified or boronic acid-modified polyolefin layer.

Still another preferred embodiment of the method of producing a shaped article of the invention comprises applying a powder of a barrier material (B), after melting it, to a substrate of a polyolefin (A), followed by applying a powder of a thermoplastic resin (C) having an elastic modulus at 20° C. of at most 500 kg/cm², after melting it, to the resulting layer of the barrier material (B).

Also preferred is an embodiment that comprises applying a powder of a thermoplastic resin (C) having an elastic modulus at 20° C. of at most 500 kg/cm², after melting it, to a substrate of a polyolefin (A), followed by applying a powder of a barrier material (B), after melting it, to the resulting layer of the thermoplastic resin (C).

In a preferred embodiment of the invention, the polyolefin (A) is a high-density polyethylene.

In another preferred embodiment of the invention, the barrier material (B) is at least one selected from a group consisting of ethylene-vinyl alcohol copolymers, polyamides, aliphatic polyketones and polyesters.

In still another preferred embodiment of the invention, the barrier material (B) is a thermoplastic resin through which the gasoline permeation amount is 100 g·20 μm/m²·day (measured at 40° C. and 65% RH) and/or the oxygen transmission rate is 100 cc·20 μm/m²·day·atm (measured at 20° C. and 65% RH).

In still another preferred embodiment of the invention, the barrier material (B) is a resin composition comprising from 50 to 95% by weight of an ethylene-vinyl alcohol copolymer and from 5 to 50% by weight of a boronic acid-modified polyolefin. In still another preferred embodiment of the invention, the barrier material (B) is a resin composition comprising from 50 to 95% by weight of an ethylene-vinyl alcohol copolymer and from 5 to 50% by weight of multi-layered polymer particles.

The invention also relates to a shaped article produced by applying a powder of a barrier material (B), after melting it, to at least a part of the surface of a substrate of a polyolefin (A). In a preferred embodiment of the invention, the shaped article produced through injection molding. In other words, the preferred embodiment of the shaped article is a product of injection molding.

Another preferred embodiment of the shaped article is a head of a tubular container. Still another preferred embodiment of the shaped article is a component for fuel containers.

Still another preferred embodiment of the shaped article is a co-extrusion blow-molded container that comprises an interlayer of a barrier resin (D) and inner and outer layers of a polyolefin (A). More preferably, the co-extrusion blow-molded container is a fuel container. Still more preferably, the co-extrusion blow-molded fuel container has a laminate structure of such that the interlayer of a barrier resin (D) is laminated with inner and outer layers of high-density polyethylene via an adhesive resin layer of a carboxylic acid-modified polyolefin.

In still another preferred embodiment of the shaped article, the barrier resin (D) is at least one selected from a group consisting of ethylene-vinyl alcohol copolymers, polyamides and aliphatic polyketones. In still another preferred embodiment of the shaped article, the barrier resin (D) is a thermoplastic resin through which the gasoline permeation amount is 100 g·20 μm/m²·day (measured at 40° C. and 65% RH) and/or the oxygen transmission rate is 100 cc·20 μm/m²·day·atm (measured at 20° C. and 65% RH).

Still another preferred embodiment of the shaped article of the invention is a co-extrusion blow-molded fuel container comprising an interlayer of a barrier resin (D) and inner and outer layers of a polyolefin (A), of which the cutting face of the pinch-off part is coated with a melted powder of a barrier material (B).

Still another preferred embodiment of the shaped article of the invention is a co-extrusion blow-molded fuel container comprising an interlayer of a barrier resin (D) and inner and outer layers of a polyolefin (A), which is constructed to have an opening through its body and in which the cutting face of the layer existing outside the interlayer is coated with a melted powder of a barrier material (B).

Still another preferred embodiment of the shaped article of the invention is a co-extrusion blow-molded fuel container comprising an interlayer of a barrier resin (D) and inner and outer layers of a polyolefin (A), which is constructed to have an opening through its body with a component attached to the opening and in which the component is coated with a melted powder of a barrier material (B).

### BRIEF DESCRIPTION OF DRAWINGS

FIG. 1 is a view showing fuel transmission through the pinch-off part of a co-extrusion blow-molded fuel container (in which 11 indicates a polyolefin (A); and 12 indicates a barrier resin (D)).

FIG. 2 is a view showing fuel transmission through the opening of the body of a co-extrusion blow-molded fuel container equipped with a component to the opening (in which 21 indicates a polyolefin (A); 22 indicates a barrier resin (D); 23 indicates a connector to the fuel container; and 24 indicates a fuel pipe).

FIG. 3 is a view showing an injection-molded, cylindrical single-layered article (connector-like article).

FIG. 4 is a view showing one embodiment of using a connector-like article (in which 41 indicates a connector-like article; 42 indicates the body of a container; and 43 indicates a pipe).

### DETAILED DESCRIPTION OF THE PREFERRED EMBODIMENTS

Preferably, the polyolefin (A) for use in the invention is any of olefin homopolymers or copolymers such as linear low-density polyethylene, low-density polyethylene, medium-density polyethylene, high-density polyethylene, ethylene-vinyl acetate copolymers, ethylene-propylene copolymers, polypropylene, propylene-α-olefin copolymers (with α-olefin having from 4 to 20 carbon atoms), polybutene, polypentene, etc.; carboxylic acid-modified polyolefins, boronic acid-modified polyolefins, etc. In case where the shaped article of the invention is a component for fuel containers or a co-extrusion blow-molded fuel container, high-density polyethylene is especially preferred for the polyolefin (A) in view of its stiffness, impact resistance, moldability, draw-down resistance and gasoline resistance.

Preferably, the lowermost limit of the melt flow rate (MFR, measured at 190° C. under a load of 2160 g) of the polyolefin (A) for use in the invention is at least 0.01 g/10 min, more preferably at least 0.05 g/l min, even more preferably at least 0.1 g/10 min. The uppermost limit of MFR thereof is preferably at most 50 g/10 min, more preferably at most 30 g/10 min, most preferably at most 10 g/10 min.

The substrate of a polyolefin (A) in the invention may be a single layer or may also be a multilayer which comprises a plurality of different resins. For improving the adhesiveness between the barrier material (B) and the substrate of a polyolefin (A), it is desirable that the substrate of a polyolefin (A) is multi-layered structure comprising a substantially non-modified polyolefin and a carboxylic acid-modified or boronic acid-modified polyolefin. A barrier material (B) is, after having been melted, applied to the layer of a carboxylic acid-modified or boronic acid-modified polyolefin of the multi-layered structure, thereby ensuring good adhesiveness between the two layers. An especially preferred embodiment of the multi-layered structure comprises a layer of high-density polyethylene and a layer of a carboxylic acid-modified or boronic acid-modified polyolefin.

The carboxylic acid-modified polyolefin for use in the invention is a copolymer comprising an olefin, especially an α-olefin and at least one comonomer selected from a group consisting of unsaturated carboxylic acids, unsaturated carboxylates and unsaturated carboxylic acid anhydrides, and it includes polyolefins having a carboxyl group in the molecule and those in which all or a part of the carboxyl group forms a metal salt. The base polyolefin of the carboxylic acid-modified polyolefin may be any type of polyolefins, and its preferred examples are polyethylene (e.g., high-density polyethylene (HDPE), low-density polyethylene (LDPE), linear low-density polyethylene (LLDPE), very-low-density polyethylene (VLDPE), etc.), polypropylene, propylene copolymers, ethylene-vinyl acetate copolymers, etc.

The unsaturated carboxylic acids include acrylic acid, methacrylic acid, maleic acid, monomethyl maleate, monoethyl maleate, itaconic acid, etc.; and especially preferred is acrylic acid or methacrylic acid. The unsaturated carboxylic acid content of the modified polyolefin preferably falls between 0.5 and 20 mol %, more preferably between 2 and 15 mol %, even more preferably between 3 and 12 mol %.

Preferred examples of the unsaturated carboxylates are methyl acrylate, ethyl acrylate, isopropyl acrylate, isobutyl acrylate, n-butyl acrylate, 2-ethylhexyl acrylate, methyl methacrylate, isobutyl methacrylate, diethyl maleate, etc. Especially preferred is methyl methacrylate. The unsaturated carboxylate content of the modified polyolefin preferably falls between 0.5 and 30 mol %, more preferably between 1 and 25 mol %, even more preferably between 2 and 20 mol %.

Examples of the unsaturated carboxylic acid anhydrides are itaconic anhydride, maleic anhydride, etc. Especially preferred is maleic anhydride. The unsaturated carboxylic acid anhydride content of the modified polyolefin preferably falls between 0.0001 and 5 mol %, more preferably between 0.0005 and 3 mol %, even more preferably between 0.001 and 1 mol %. Examples of other monomers that may be in the copolymers are vinyl esters such as vinyl propionate, and carbon monoxide, etc.

The metal ion of the metal salt of the carboxylic acid-modified polyolefin includes, for example, alkali metals such as lithium, sodium, potassium, etc.; alkaline earth metals such as magnesium, calcium, etc.; transition metals such as zinc, etc. The degree of neutralization of the metal salt of the carboxylic acid-modified polyolefin may be up to 100%, but is preferably at most 90%, more preferably at most 70%. The lowermost limit of the degree of neutralization will be generally at least 5%, but preferably at least 10%, more preferably at least 30%.

Of the above-mentioned carboxylic acid-modified polyolefins, preferred are ethylene-methacrylic acid copolymers (EMAA), ethylene-acrylic acid copolymers (EAA), ethylene-methyl methacrylate copolymers (EMMA), maleic anhydride-modified polyethylenes, maleic anhydride-modified polypropylenes and their metal salts, in view of their adhesiveness to the barrier material (B). Especially preferred are ethylene-methacrylic acid copolymers (EMAA) and their metal salts.

Preferably, the lowermost limit of the melt flow rate (MFR, at 190° C. under a load of 2160 g) of the carboxylic acid-modified polyolefin for use in the invention is 0.01 g/10 min, more preferably at least 0.05 g/10 min, even more preferably at least 0.1 g/10 min. The uppermost limit of MFR thereof is preferably at most 50 g/10 min, more preferably at most 30 g/10 min, most preferably at most 10 g/10 min. These carboxylic acid-modified polyolefins may be used either singly or as combined to be a mixture of two or more of them.

The boronic acid-modified polyolefin for use in the invention is a polyolefin having at least one functional group selected from boronic acid groups, borinic acid groups, and boron-containing groups capable of being converted into boronic acid groups or borinic acid groups in the presence of water.

In the polyolefin having at least one functional group selected from boronic acid groups, borinic acid groups, and boron-containing groups capable of being converted into boronic acid groups or borinic acid groups in the presence of water, which is for use in the invention, at least one functional group selected from boronic acid groups, borinic acid groups, or boron-containing groups capable of being converted into boronic acid groups or borinic acid groups in the presence of water is bonded to the main chain, the side chain or the terminal via-boron-carbon bonding therebetween. Of such polyolefins, preferred are those having the functional group bonded to the side chain or to the terminal. The terminal is meant to include one terminal and both terminals of the polymer. In view of their adhesiveness to the barrier material (B), especially preferred are polyolefins with the functional group bonded to the side chain.

The carbon of the boron-carbon bonding is derived from the base polymer of polyolefin to be mentioned below, or from the boron compound to be reacted with the base polymer. One preferred embodiment of the boron-carbon bonding is bonding of boron to the alkylene group in the main chain, the terminal or the side chain of the polymer. Boronic acid group-having polyolefins are preferred for use in the invention, and these will be described below. The boronic acid group referred to herein is represented by the following formula (I):

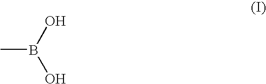

The boron-containing group capable of being converted into a boronic acid group in the presence of water (this will be hereinafter referred to as a boron-containing group) may be any and every boron-containing group capable of being hydrolyzed in the presence of water to give a boronic acid group of formula (I). Representative examples of the group are boron ester groups of the following general formula (II), boronic acid anhydride groups of the following general formula (III), and boronic acid salt groups of the following general formula (IV): 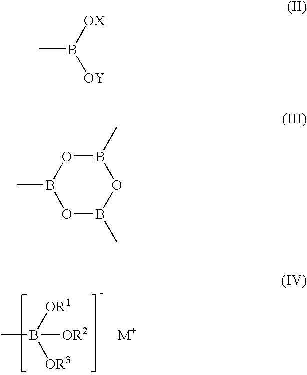
wherein X and Y each represent a hydrogen atom, an aliphatic hydrocarbon group (e.g., a linear or branched alkyl or alkenyl group having from 1 to 20 carbon atoms), an alicyclic hydrocarbon group (e.g., a cycloalkyl group, a cycloalkenyl group), or an aromatic hydrocarbon group (e.g., a phenyl group, a biphenyl group); X and Y may be the same or different, and X and Y may be bonded to each other, but X and Y must not be hydrogen atoms at the same time; R¹, R² and R³ each represent a hydrogen atom, an aliphatic hydrocarbon group, an alicyclic hydrocarbon group, or an aromatic hydrocarbon group, like X and Y, and R¹, R² and R³ may be the same or different; M represents an alkali metal or an alkaline earth metal; and the groups X, Y R¹, R² and R³ may have any other groups such as a carboxyl group, a halogen atom, etc.

Specific examples of the groups of formulae (II) to (IV) are boronic acid ester groups such as a dimethyl boronate group, a diethyl boronate group, a dipropyl boronate group, a diisopropyl boronate group, a dibutyl boronate group, a dihexyl boronate group, a dicyclohexyl boronate group, an ethylene glycol boronate group, a propylene glycol boronate group (1,2-propanediol boronate group, 1,3-propanediol boronate group), a trimethylene glycol boronate group, a neopentyl glycol boronate group, a catechol boronate group, a glycerin boronate group, a trimethylolethane boronate group, etc.; boronic acid anhydride groups; boronic acid alkali metal salt groups, boronic acid alkaline earth metal salt groups, etc. The boron-containing group capable of being converted into a boronic acid group or a borinic acid group in the presence of water is meant to indicate a group capable of being converted into a boronic acid group or a borinic acid group when the polyolefin containing it is hydrolyzed in water or in a mixed liquid comprising water and an organic solvent (toluene, xylene, acetone, etc.) at a reaction temperature falling between 25° C. and 150° C. and for a reaction time falling between 10 minutes and 2 hours.

The functional group content of the polymer is not specifically defined, but preferably falls between 0.0001 and 1 meq/g (milli-equivalent/g), more preferably between 0.001 and 0.1 meq/g.

The base polymer of the polyolefin which has the boron-containing group is a polymer of olefinic monomers of typically α-olefins such as ethylene, propylene, 1-butene, isobutene, 3-methylpentene, 1-hexene, 1-octene, etc.

The base polymer is a polymer of one, two, three or more of such monomers. For the base polymer, especially preferred are ethylenic polymers (very-low-density polyethylene, low-density polyethylene, medium-density polyethylene, high-density polyethylene, linear low-density polyethylene, ethylene-vinyl acetate copolymers, ethylene-acrylate copolymers, metal salts of ethylene-acrylic acid copolymers (Na, K, Zn ionomers), ethylene-propylene copolymers).

A typical method for producing the olefinic polymers for use in the invention, which have a boronic acid group or a boron-containing group-having, is described. Olefinic polymers having a boronic acid group or a boron-containing group capable of being converted into a boronic acid group in the presence of water can be obtained by reacting a carbon-carbon double bond-having olefinic polymer with a borane complex and a trialkyl borate in a nitrogen atmosphere to give a dialkyl boronate group-having olefinic polymer followed by further reacting the resulting polymer with water or an alcohol. In case where an olefinic polymer having a double bond at the terminal is processed according to the method, the resulting olefinic polymer shall have a boronic acid group or a boron-containing group capable of being converted into a boronic acid group in the presence of water, at the terminal. On the other hand, in case where an olefinic polymer having a double bond in the side chain or in the main chain is processed according to the method, the resulting olefinic polymer shall have a boronic acid group or a boron-containing group capable of being converted into a boronic acid group in the presence of water, in the side chain.

Typical methods for producing the starting, double bond-having olefinic polymer are (1) a method of utilizing the double bond being present in a small amount at the terminal of an ordinary olefinic polymer; (2) a method of pyrolyzing an ordinary olefinic polymer in the absence of oxygen to give an olefinic polymer having a double bond at the terminal; and
(3) a method of copolymerizing an olefinic monomer and a dienic polymer to give a copolymer of the olefinic monomer and the dienic monomer. For (1), usable is any known method of producing ordinary olefinic polymers, in which, however, preferably used is a metallocene polymerization catalyst, and hydrogen serving as a chain transfer agent is not used (for example, DE 4,030,399). In (2), an olefinic polymer is pyrolyzed in the absence of oxygen, for example, in a nitrogen atmosphere or in high vacuum at a temperature falling between 300° C. and 500° C. in an ordinary manner (for example, U.S. Pat. Nos. 2,835,659, 3,087,922). For (3), usable is a method for producing olefin-diene copolymers in the presence of a known Ziegler catalyst (for example, Japanese Patent Laid-Open No. 44281/1975, DE 3,021,273).

Starting from the double bond-having olefinic polymers produced in the above-mentioned methods (1) and (2), obtained are polyolefins having at least one functional group selected from boronic acid groups, borinic acid groups, and boron-containing groups capable of being converted into boronic acid groups or borinic acid groups in the presence of water, at the terminal. Starting from the double bond-having olefinic polymers produced in the method (3), obtained are polyolefins having the functional group in the side chain.

Preferred examples of the borane complex are borane-tetrahydrofuran complex, borane-dimethylsulfide complex, borane-pyridine complex, borane-trimethylamine complex, borane-triethylamine, etc. Of these, more preferred are borane-triethylamine complex and borane-triethylamine complex. The amount of the borane complex to be applied to the olefinic polymer preferably falls between ⅓ equivalents and 10 equivalents to the double bond of the polymer. Preferred examples of the trialkyl borates are lower alkyl esters of boric acid such as trimethyl borate, triethyl borate, tripropyl borate, tributyl borate. The amount of the trialkyl borate to be applied to the olefinic polymer preferably falls between 1 and 100 equivalents to the double bond of the polymer. The solvent is not necessarily used for the reaction, but it is, when ever used, preferably a saturated hydrocarbon solvent such as hexane, heptane, octane, decane, dodecane, cyclohexane, ethylcyclohexane, decalin, etc.

For the reaction for introducing a dialkyl boronate group into olefinic polymers, the temperature preferably falls between 25° C. and 300° C., more preferably between 100 and 250° C.; and the time preferably falls between 1 minute and 10 hours, more preferably between 5 minutes and 5 hours.

For the reaction of the dialkyl boronate group-having olefinic polymer with water or an alcohol, generally used is an organic solvent such as toluene, xylene, acetone, ethyl acetate, etc. In such a reaction solvent, the olefinic polymer is reacted with a large excessive amount, from 1 to 100 equivalents or more to the boronate group in the polymer, of water or an alcohol such as methanol, ethanol, butanol or the like, or a polyalcohol such as ethylene glycol, 1,2-propanediol, 1,3-propanediol, neopentyl glycol, glycerin, trimethylolethane, pentaerythritol, dipentaerythritol or the like, at a temperature falling between 25° C. and 150° C. for from 1 minute to 1 day or so. Of the above-mentioned functional groups, the boron-containing group capable of being converted into a boronic acid group is meant to indicate a group capable of being converted into a boronic acid group when the polymer having it is hydrolyzed in water or in a mixed solvent of water and an organic solvent (toluene, xylene, acetone, etc.) for a reaction period of time falling between 10 minutes and 2 hours at a reaction temperature falling between 25° C. and 150° C.

Preferably, a powder of a barrier material (B) is, after having been melted, applied to the substrate of a polyolefin (A), and a powder of a thermoplastic resin (C) having an elastic modulus at 20° C. of at most 500 kg/cm² is, after having been melted, applied to the resulting layer of the barrier material (B), for improving the impact strength of the coating film of the barrier material (B). The impact strength of the coating film of the barrier material (B) can also be improved by applying a powder of the thermoplastic resin (C), after melting it, to the substrate of a polyolefin (A), followed by applying a powder of the barrier material (B), after melting it, to the resulting layer of the thermoplastic resin (C). Preferred examples of the thermoplastic resin (C) having an elastic modulus at 20° C. (measured according to ASTM D882) of at most 500 kg/cm², which is employed in the invention, are rubbers such as EPDM (ethylene-propylene-diene rubber), NR (natural rubber), isoprene rubber, butadiene rubber, IIR (butyl rubber), etc.; as well as very-low-density polyethylene (VLDPE), ethylene-vinyl acetate copolymers (EVA), copolymers of aromatic vinyl compounds and conjugated diene compounds, ethylene-propylene copolymer elastomers (EPR), etc. However, these are not limitative. Of these, preferred are copolymers of aromatic vinyl compounds and conjugated diene compounds, and ethylene-propylene copolymer elastomers (EPR). The ethylene-propylene copolymers are not specifically defined, including, for example, ethylene-propylene random copolymers and block copolymers. For the monomer blend ratio to give copolymers having good flexibility, it is desirable that the amount of one monomer is at least 20 parts by weight.

In the copolymers of aromatic vinyl compounds and conjugated diene compounds for use in the invention, the aromatic vinyl compounds are not specifically defined. The compounds include, for example, styrenes such as styrene, α-methylstyrene, 2-methylstyrene, 4-methylstyrene, 4-propylstyrene, 4-t-butylstyrene, 4-cyclohexylstyrene, 4-dodecylstyrene, 2-ethyl-4-benzylstyrene, 4-(phenylbutyl)styrene, 2,4,6-trimethylstyrene, monofluorostyrene, difluorostyrene, monochlorostyrene, dichlorostyrene, methoxystyrene, t-butoxystyrene, etc.; vinyl group-containing aromatic compounds such as 1-vinylnaphthalene, 2-vinylnaphthalene, etc.; vinylene group-containing aromatic compounds such as indene, acenaphthylene, etc. The copolymers may comprise one or more different types of aromatic vinyl monomer units, for which, however, preferred are units derived from styrenes.

In the copolymers of aromatic vinyl compounds and conjugated diene compounds for use in the invention, the conjugated diene compounds are not also specifically defined. The compounds include, for example, butadiene, isoprene, 2,3-dimethylbutadiene, pentadiene, hexadiene, etc. The conjugated diene compounds may be partially or completely hydrogenated. Examples of copolymers of partially hydrogenated aromatic vinyl compounds and conjugated diene compounds are styrene-ethylene-butylene-styrene triblock copolymers (SEBS), styrene-ethylene-propylene-styrene triblock copolymers (SEPS), hydrogenated derivatives of styrene-conjugated diene copolymers, etc.

The barrier material (B) for use in the invention is preferably a thermoplastic resin through which the gasoline permeation amount is 100 g·20 μm/m²·day (measured at 40° C. and 65% RH) and/or the oxygen transmission rate is 100 cc·20 μm/m²·day·atm (measured at 20° C. and 65% RH). More preferably, the uppermost limit of the gasoline permeation amount through the resin is at most 10 g·20 μm/m²·day, even more preferably at most 1 g·20 μm/m²·day, still more preferably at most 0.5 g·20 μm/m²·day, most preferably at most 0.1 g·20 μm/m²·day. Gasoline to be used for determining the gasoline permeation amount through the resin is a model gasoline of mixed toluene/isooctane (=1/1 by volume), which is referred to as Ref. C. More preferably, the uppermost limit of the oxygen transmission rate through the resin is at most 50 cc·20 μm/m²·day·atm, even more preferably at most 10 cc·20 μm/m²·day·atm, most preferably at most 5 cc·20 μm/m²·day·atm.

In one preferred embodiment of the invention, the step of applying the powder of a barrier material (B), after melting it, to the substrate of a polyolefin (A) is effected according to a flame spray coating process. Accordingly, the barrier material (B) is preferably a thermoplastic resin. For further improving the gasoline barrier properties of the shaped article of the invention, it is desirable that the thermoplastic resin for the barrier material (B) has a solubility parameter (obtained according to the Fedors' formula) of larger than 11.

Also preferably, the barrier material (B) for use herein is at least one selected from a group consisting of ethylene-vinyl alcohol copolymers (EVOH), polyamides, aliphatic polyketones and polyesters. In view of its oxygen barrier properties, the barrier material (B) is more preferably a polyamide or EVOH, most preferably EVOH. In view of their gasoline barrier properties, however, preferred are polyamides, polyesters and EVOH, and most preferred is EVOH.

Preferably, EVOH for the barrier material (B) in the invention is a resin to be obtained by saponifying an ethylene-vinyl ester copolymer, and its ethylene content may fall between 5 and 60 mol %. The lowermost limit of the ethylene content of the resin is preferably at least 15 mol %, more preferably at least 25 mol %, even more preferably at least 30 mol %, still more preferably at least 35 mol %, most preferably at least 40 mol %. The uppermost limit of the ethylene content of the resin is preferably at most 55 mol %, more preferably at most 50 mol %. The melt moldability of EVOH having an ethylene content of smaller than 5 mol % is poor, and uniformly coating the EVOH melt over the substrate of a polyolefin (A) is difficult. On the other hand, the gasoline barrier properties and oxygen barrier properties of EVOH having an ethylene content of larger than 60 mol % are poor.

The degree of saponification of the vinyl ester moiety of EVOH for use in the present invention is at least 85%. Preferably, it is at least 90%, more preferably at least 95%, even more preferably at least 98%, most preferably at least 99%. The gasoline barrier properties and the oxygen barrier properties and even the thermal stability of EVOH having a degree of saponification of smaller than 85% are poor.

One typical example of the vinyl ester to be used for producing EVOH is vinyl acetate. However, any other vinyl esters of fatty acids (vinyl propionate, vinyl pivalate, etc.) are also usable for producing it. EVOH may contain from 0.0002 to 0.2 mol % of a comonomer, vinylsilane compound. The vinylsilane compound includes, for example, vinyltimethoxysilane, vinyltriethoxysilane, vinyltri(β-methoxy-ethoxy)silane, β-methacryloxypropylmethoxysilane. Of these, preferred are vinyltrimethoxysilane and vinyltriethoxysilane. Not interfering with the object of the invention, EVOH may be copolymerized with any other comonomers, for example, propylene, butylene, or unsaturated carboxylic acids and their esters such as (meth)acrylic acid, methyl (meth)acrylate, ethyl (meth)acrylate, etc., vinylpyrrolidones such as N-vinylpyrrolidone, etc.

Also not interfering with the object of the invention, a boron compound may be added to EVOH. The boron compound includes boric acids, borates, salts of boric acids, boron hydrides, etc. Concretely, boric acids include orthoboric acid, metaboric acid, tetraboric acid, etc.; borates includes trimethyl borate, triethyl borate, etc.; and salts of boric acids include alkali metal salts and alkaline earth metal salts of the above-mentioned boric acids, as well as borax, etc. Of these compounds, preferred is orthoboric acid. In case where such a boron compound is added to EVOH, the boron compound content of EVOH preferably falls between 20 and 2000 ppm, more preferably between 50 and 1000 ppm, in terms of the boron element.

As being effective for improving the interlayer adhesiveness between EVOH and the substrate of a polyolefin (A), an alkali metal salt is preferably added to EVOH in an amount of from 5 to 5000 ppm in terms of the alkali metal element.

More preferably, the alkali metal salt content of EVOH falls between 20 and 1000 ppm, even more preferably between 30 and 500 ppm, in terms of the alkali metal element. The alkali metal includes lithium, sodium, potassium, etc. The alkali metal salt includes mono-metal salts of aliphatic carboxylic acids, aromatic carboxylic acids and phosphoric acids, as well as mono-metal complexes, etc. For example, it includes sodium acetate, potassium acetate, sodium phosphate, lithium phosphate, sodium stearate, potassium stearate, sodium ethylenediaminetetraacetate, etc. Of these, preferred are sodium acetate and potassium acetate.

Also preferably, EVOH for use in the invention contains a phosphate compound in an amount of from 20 to 500 ppm, more preferably from 30 to 300 ppm, most preferably from 50 to 200 ppm, in terms of the phosphate radical. In case where the phosphate compound content of EVOH is smaller than 20 ppm or larger than 500 ppm, the thermal stability of EVOH is low. If so, there is possibility that a melt of powdery EVOH applied to the substrate of a polyolefin (A) will often gel and the thickness of the coating layer of EVOH could not be uniform.

The type of the phosphate compound to be added to EVOH is not specifically defined. It includes various acids such as phosphoric acid, phosphorous acid, etc., and their salts. Any phosphate of any type of primary phosphates, secondary phosphates and tertiary phosphates may be in EVOH, and its cation is not specifically defined. Preferred are alkali metal salts and alkaline earth metal salts. Above all, especially preferred for the phosphate compound are sodium dihydrogenphosphate, potassium dihydrogenphosphate, disodium hydrogenphosphate and dipotassium hydrogenphosphate.

In the invention, the powder of EVOH is preferably applied to the substrate of a polyolefin (A) according to a flame spray coating process. Therefore, the fluidity of the melt of EVOH must be high. Preferably, the melt flow rate (MFR, at 190° C. under a load of 2160 g) of EVOH for the barrier material (B) in the invention falls between 0.1 and 50 g/10 min, more preferably between 1 and 40 g/10 min, even more preferably between 5 and 30 g/10 min. For EVOH having a melting point of around 190° C. or above 190° C., its MFR is measured under a load of 2160 g at different temperatures not lower than its melting point. The data are plotted on a semi-logarithmic graph with the horizontal axis indicating the reciprocal of the absolute temperature and the vertical axis indicating the logarithm of the melt flow rate measured, and the value corresponding to 190° C. is extrapolated from the curve of the thus-plotted data. One type of EVOH resin or two or more different types thereof may be used either singly or as combined.

Not interfering with the object of the invention, any of thermal stabilizers, UV absorbents, antioxidants, colorants, other resins (polyamides, polyolefins, etc.) and also plasticizers such as glycerin, glycerin monostearate or the like may be added to EVOH. Adding metal salts of higher aliphatic carboxylic acids and hydrotalcite compounds to EVOH is effective for preventing EVOH from being thermally degraded.

Examples of hydrotalcite compounds usable herein are double salts of MₓAl_{y}(OH)_{2x+3y-2z}(A)_{z}.aH₂O (where M represents Mg, Ca or Zn; A represents CO₃ or HPO₄; and x, y, z and a each are a positive integer). Preferred examples of the compounds are mentioned below.
Mg₆Al₂ (OH)₁₆CO₃.4H₂O
Mg₈Al₂(OH)₂₀CO₃.5H₂O
Mg₅Al₂ (OH)₁₄CO₃.4H₂O
Mg₁₀Al₂(OH)₂₂(CO₃)₂.4H₂O
Mg₆Al₂ (OH)₁₆HPO₄.4H₂O
Ca₆Al₂(OH)₁₆CO₃.4H₂O
Zn₆Al₆(OH)₁₆CO₃.4H₂O
Mg_{4.5}Al₂(OH)₁₃CO₃.3.5H₂O

Also usable herein is a hydrotalcite solid solution, [Mg_{0.75}Zn_{0.25}]_{0.67}Al_{0.33}(OH)₂(CO₃)_{0.167}.0.45H₂O described in Japanese Patent Laid-Open No. 308439/1989 (U.S. Pat. No. 4,954,557).

Metal salts of higher aliphatic carboxylic acids for use herein are those of higher fatty acids having from 8 to 22 carbon atoms. For those, higher fatty acids having from −8 to 22 carbon atoms include lauric acid, stearic acid, myristic acid, etc. Metals include sodium, potassium, magnesium, calcium, zinc, barium, aluminium, etc. Of those, preferred are alkaline earth metals such as magnesium, calcium, barium, etc.

The content of such a metal salt of a higher aliphatic carboxylic acid or a hydrotalcite compound to be in EVOH preferably falls between 0.01 and 3 parts by weight, more preferably between 0.05 and 2.5 parts by weight, relative to 100 parts by weight of EVOH.

Polyamides usable herein for the barrier material (B) are amido bond-having polymers, including, for example, homopolymers such as polycapramide (nylon-6), polyundecanamide (nylon-11), polylauryllactam (nylon-12), polyhexamethylene adipamide (nylon-6,6), polyhexamethylene sebacamide (nylon-6,12); caprolactam/lauryllactam copolymer (nylon-6/12), caprolactam/aminoundecanoic acid polymer (nylon-6/11), caprolactam/ω-aminononanoic acid polymer (nylon-6,9), caprolactam/hexamethylenediammonium adipate copolymer (nylon-6/6,6), caprolactam/hexamethylenediammonium adipate/hexamethylenediammonium sebacate copolymer (nylon-6/6,6/6,12); aromatic nylons such as adipic acid/metaxylenediamine copolymer (hereinafter referred to as MXD-6), hexamethylenediamine/m,p-phthalic acid copolymer, etc. One or more of these polyamides are usable herein either singly or as combined.

Of these polyamides, preferred are nylon-6 and nylon-12, as having good gasoline barrier properties. For alcohol-containing gasoline with methanol, ethanol or the like, or for oxygen-containing gasoline such as MTBE (methyl tert-butyl ether)-containing gasoline, preferred is nylon-12. In view of its oxygen barrier properties, preferred is adipic acid/metaxylenediamine copolymer (MXD-6).

Aliphatic polyketones usable for the barrier material (B) in the invention are carbon monoxide-ethylene copolymers, which are obtained by copolymerizing carbon monoxide and ethylene, or by copolymerizing essentially carbon monoxide and ethylene with other unsaturated compounds except ethylene. The unsaturated compounds except ethylene include α-olefins having at least 3 carbon atoms, styrenes, dienes, vinyl esters, aliphatic unsaturated carboxylates, etc. The copolymers may be random copolymers or alternate copolymers. Alternate copolymers having a higher degree of crystallinity are preferred, in view of their barrier properties.

More preferred are alternate copolymers containing a third component in addition to carbon monoxide and ethylene, as their melting point is low and therefore their melt stability is good. α-olefins are preferred for the comonomer, including, for example, propylene, butene-1, isobutene, pentene-1, 4-methylpentene-1, hexene-1, octene-1, dodecene-1, etc. More preferred are α-olefins having from 3 to 8 carbon atoms; and even more preferred is propylene. The amount of the comonomer, α-olefin preferably falls between 0.5 and 7% by weight of the polyketone, as ensuring good crystallinity of the polymer. Another advantage of the polyketone of which the comonomer content falls within the defined range is that the coatability of the melt of its powder is good.

For the other comonomers, dienes preferably have from 4 to 12 carbon atoms, including butadiene, isoprene, 1,5-hexadiene, 1,7-octadiene, 1,9-decadiene, etc. Vinyl esters include vinyl acetate, vinyl propionate, vinyl pivalate, etc. Aliphatic unsaturated carboxylic acids and their salts and esters include acrylic acid, methacrylic acid, maleic anhydride, maleic acid, itaconic acid, acrylates, methacrylates, monomaleates, dimaleates, monofumarates, difumarates, monoitaconates, diitaconates (these esters may be alkyl esters such as methyl esters, ethyl esters, etc.), salts of acrylic acid, salts of maleic acid, salts of itaconic acid (these salts may be mono- or di-valent metal salts). Not only one but also two or more of these comonomers may be used in preparing the copolymers, either singly or as combined.

Polyketones for use herein may be produced in any known method, for example, according to the methods described in U.S. Pat. No. 2,495,286, and Japanese Patent Laid-Open Nos. 128690/1978, 197427/1984, 91226/1986, 232434/1987, 53332/1987, 3025/1988, 105031/1988, 154737/1988, 149829/1989, 201333/1989, 67319/1990, etc., but are not limited thereto.

Preferably, the melt flow rate (MFR, at 230° C. under a load of 2160 g) of the polyketone for use in the invention falls between 0.01 and 50 g/10 min, most preferably between 0.1 and 30 g/10 min. The polyketone has good fluidity, so far as its MFR falls within the defined range, and the coatability of the melt of a powder of the polyketone is good.

Polyesters usable for the barrier material (B) in the invention are preferably thermoplastic polyester resins. The thermoplastic polyester resins are polycondensates comprising, as the essential ingredients, aromatic dicarboxylic acids or their alkyl esters and diols. For attaining the object of the invention, especially preferred are polyester resins comprising ethylene terephthalate as one essential ingredient. Preferably, the total (in terms of mol %) of the terephthalic acid unit and the ethylene glycol unit constituting the polyester resin for use in the invention is at least 70 mol %, more preferably at least 90 mol % of all structural units constituting it. Polyester are preferred for the barrier material (B), as having good gasoline barrier properties. Even to alcohol-containing gasoline with methanol, ethanol or the like and to oxygen-containing gasoline such as MTBE (methyl tert-butyl ether)-containing gasoline or the like, polyesters still enjoy good gasoline barrier properties.

EVOH is especially preferred for the barrier material (B) for use in the invention, as having good gasoline barrier properties and good oxygen barrier properties.

For the barrier material (B), also preferred is a resin composition comprising from 50 to 95% by weight of an ethylene-vinyl alcohol copolymer and from 5 to 50% by weight of a boronic acid-modified polyolefin. A powder of the resin composition for the barrier material (B) is, after having been melted, applied to a substrate of a polyolefin (A). In the resulting shaped article coated with the barrier material (B), the impact strength of the coating film is improved. The boronic acid-modified polyolefin content of the resin composition falls between 5% by weight and 50% by weight. If it is smaller than 5% by weight, the impact strength of the barrier material (B) of the resin composition could not be high. On the other hand, if the boronic acid-modified polyolefin content of the resin composition is larger than 50% by weight, the barrier properties of the resin film are poor. In view of the balance-of the barrier properties and the impact strength of the resin film, it is more desirable that the resin composition comprises from 60 to 95% by weight of an ethylene-vinyl alcohol copolymer and from 5 to 40% by weight of a boronic acid-modified polyolefin, even more desirably from 70 to 95% by weight of an ethylene-vinyl alcohol copolymer and from 5 to 30% by weight of a boronic acid-modified polyolefin. In view of the impact strength of the coating film of the barrier material (B), it is desirable that the boronic acid-modified polyolefin to be added to EVOH has at least one functional group selected from boronic acid groups, borinic acid groups and boron-containing groups capable of being converted into boronic acid or borinic acid groups in the presence of water, at its terminal.

The resin composition for the barrier material (B) that comprises EVOH and a boronic acid-modified polyolefin may be a dry blend of a powder of EVOH and a powder of a boronic acid-modified polyolefin. However, for ensuring stable morphology of the resin composition that comprises EVOH and a boronic acid-modified polyolefin, and for ensuring uniform coats of the barrier material (B), it is desirable that the two components are kneaded in melt.

Also preferably, the resin composition for the barrier material (B) comprises from 50 to 95% by weight of an ethylene-vinyl alcohol copolymer and from 5 to 50% by weight of multi-layered polymer particles. A powder of the resin composition for the barrier material (B) is, after having been melted, applied to a substrate of a polyolefin (A). In the resulting shaped article coated with the barrier material (B), the impact strength of the coating film is improved. The content of the multi-layered polymer particles in the resin composition falls between 5% by weight and 50% by weight. If it is smaller than 5% by weight, the impact strength of the barrier material (B) of the resin composition could not be improved. On the other hand, if the content of the multi-layered polymer particles in the resin composition is larger than 50 by weight, the barrier properties of the resin film are poor. In view of the balance of the barrier properties and the impact strength of the resin film, it is more desirable that the resin composition comprises from 60 to 95% by weight of an ethylene-vinyl alcohol copolymer and from 5 to 40% by weight of multi-layered polymer particles, even more desirably from 70 to 95% by weight of an ethylene-vinyl alcohol copolymer and from 5 to 30% by weight of multi-layered polymer particles.

The multi-layered polymer particles for use in the invention have at least a hard layer and a rubber layer. Either of the two layers may be the outermost layer of each particle, but it is desirable that the hard layer is the outermost layer and the rubber layer is inside the particles. The rubber layer referred to herein is a polymer layer having a glass transition point (hereinafter referred to as Tg) of not higher than 25° C.; and the hard layer is a polymer layer having Tg of higher than 25° C. For their structure, the multi-layered polymer particles may be composed of two or three layers, or even four or more layers. Two-layered particles will have a structure of rubber layer (core layer)/hard layer (outermost layer); three-layered particles will have a structure of hard layer (core layer)/rubber layer (interlayer)/hard layer (outermost layer), or rubber layer (core layer)/rubber layer (interlayer)/hard layer (outermost layer), or rubber layer (core layer)/hard layer (interlayer)/hard layer (outermost layer); and one example of the structure of four-layered particles is rubber layer (core layer)/hard layer (interlayer)/rubber layer (interlayer)/hard layer (outermost layer).

The composition of the rubber layer in the multi-layered polymer particles for use in the invention is not specifically defined. For example, polymers preferred for the layer are conjugated dienic polymers such as polybutadiene, polyisoprene, butadiene-isoprene copolymers, polychloroprene, styrene-butadiene copolymers, acrylonitrile-butadiene copolymers, acrylate-butadiene copolymers, etc.; hydrogenated derivatives of such conjugated dienic polymers; olefinic rubbers such as ethylene-propylene copolymers, etc.; acrylic rubber such as polyacrylates, etc.; as well as polyorganosiloxanes, thermoplastic elastomers, ethylenic ionomer copolymers, etc. One or more of these polymers may be used for the rubber layer. Of these, preferred are acrylic rubbers, conjugated dienic polymers or hydrogenated derivatives of conjugated dienic polymers.

Acrylic rubbers for the layer may be formed by polymerizing acrylates. The acrylates may be alkyl acrylates, including, for example, methyl acrylate, ethyl acrylate, propyl acrylate, butyl acrylate, 2-ethylhexyl acrylate, octyl acrylate, etc. Of these, preferred is butyl acrylate or ethyl acrylate.

Acrylic rubbers or conjugated dienic polymers for the layer may be produced through polymerization of a monomer system that comprises essentially alkyl acrylates and/or conjugated dienic compounds. If desired, the acrylic rubbers or conjugated dienic polymers may be copolymerized with any other mono-functional polymerizable monomers in addition to the above-mentioned monomers. The mono-functional comonomers include methacrylates such as methyl methacrylate, ethyl methacrylate, propyl methacrylate, butyl methacrylate, amyl methacrylate, hexyl methacrylate, 2-ethylhexyl methacrylate, cyclohexyl methacrylate, octyl methacrylate, decyl methacrylate, dodecyl methacrylate, octadecyl methacrylate, phenyl methacrylate, benzyl methacrylate, naphthyl methacrylate, isobornyl methacrylate, etc.; aromatic vinyl compounds such as styrene, α-methylstyrene, etc.; acrylonitrile, etc. Preferably, the mono-functional comonomer accounts for at most 20% by weight of all polymerizable monomers to form the rubber layer.

Preferably, the rubber layer that forms a part of the multi-layered polymer particles for use in the invention has a crosslinked molecular chain structure to express rubber elasticity. Also preferably, the molecular chains constituting the rubber layer are grafted with those of the adjacent layers via chemical bonding therebetween. For this, it is often desirable that the monomer system to give the rubber layer through polymerization contains a small amount of a poly-functional polymerizable monomer that serves as a crosslinking agent or a grafting agent.

The poly-functional polymerizable monomer has at least two carbon-carbon double bonds in the molecule, including, for example, esters of unsaturated carboxylic acids, such as acrylic acid, methacrylic acid, cinnamic acid or the like, with unsaturated alcohols such as allyl alcohol, methallyl alcohol or the like, or with glycols such as ethylene glycol, butanediol or the like; esters of dicarboxylic acid, such as phthalic acid, terephthalic acid, isophthalic acid, maleic acid or the like, with unsaturated alcohols such as those mentioned above, etc. Specific examples of the poly-functional polymerizable monomer are allyl acrylate, methallyl acrylate, allyl methacrylate, methallyl methacrylate, allyl cinnamate, methallyl cinnamate, diallyl maleate, diallyl phthalate, diallyl terephthalate, diallyl isophthalate, divinylbenzene, ethylene glycol di(meth)acrylate, butanediol di(meth)acrylate, hexanediol di(meth)acrylate, etc. The terminology “di(meth)acrylate” is meant to indicate “diacrylate” and “dimethacrylate”. One or more of these monomers may be used either singly or as combined. Of these, preferred is allyl methacrylate.

Preferably, the amount of the poly-functional polymerizable monomer is at most 10% by weight of all the polymerizable monomers to form the rubber layer. This is because, if the poly-functional polymerizable monomer is too much, it will worsen the rubber properties of the layer, and will therefore lower the flexibility of the thermoplastic resin composition containing the multi-layered polymer particles. In case where the monomer system to form the rubber layer comprises, as the main ingredient, a conjugated dienic compound, it does not necessarily require a poly-functional polymerizable monomer since the conjugated dienic compound therein functions as a crosslinking or grafting point by itself.

Radical-polymerizable monomers are used for forming the hard layer in the multi-layered polymer particles for use herein. For example, they include alkyl methacrylates such as methyl methacrylate, ethyl methacrylate, propyl methacrylate, butyl methacrylate, etc.; alicyclic skeleton-having methacrylates such as cyclohexyl methacrylate, isobornyl methacrylate, adamantyl methacrylate, etc.; aromatic ring-having methacrylates such as phenyl methacrylate, etc.; aromatic vinyl compounds such as styrene, α-methylstyrene, etc.; acrylonitrile, etc. One or more of these radical-polymerizable monomers may be used either singly or as combined. For the radical-polymerizable monomer system for use herein, preferred is methyl methacrylate or styrene alone, or a combination comprising, as the main ingredient, any of them along with additional radical-polymerizable monomers.

Preferably, the multi-layered polymer particles for use herein has at least one functional group that is reactive with or has affinity for hydroxyl groups, as their dispersibility in EVOH is good. With the polymer particles of that type, the impact strength of the coating film of the barrier material (B) is higher. Accordingly, in polymerization to give the multi-layered polymer particles for use herein, it is desirable to use, as a part of the monomer, a radical-polymerizable compound having a functional group that is reactive with or has affinity for hydroxyl groups or having a protected functional group of that type.

Copolymerizable compounds which are reactive with or have affinity for hydroxyl groups and which are preferably used for forming the above-mentioned functional group in the multi-layered polymer particles are unsaturated compounds having a group capable of reacting with hydroxyl groups in. EVOH to form chemical bonds therewith under the mixing condition mentioned below or those having a group capable of forming intermolecular bonds such as hydrogen bonds with hydroxyl groups in EVOH also under that mixing condition. The functional group that is reactive with or has affinity for hydroxyl groups includes, for example, a hydroxyl group, an epoxy group, an isocyanate group (—NCO), an acid group such as a carboxyl group, etc., an acid anhydride group such as that derived from maleic anhydride, and a protected group which is de-protected under the mixing condition mentioned below to give any of these functional groups.

Specific examples of the unsaturated compounds are hydroxyl group-having polymerizable compounds such as 2-hydroxyethyl (meth)acrylate, 3-hydroxypropyl (meth)acrylate, 2-hydroxyethyl crotonate, 3-hydroxy-1-propene, 4-hydroxy-1-butene, cis-4-hydroxy-2-butene, trans-4-hydroxy-2-butene, etc.; epoxy group-having polymerizable compounds such as glycidyl acrylate, glycidyl methacrylate, allyl glycidyl ether, 3,4-epoxybutene, 4,5-epoxypentyl (meth)acrylate, 10,11-epoxyundecyl methacrylate, p-glycidylstyrene, etc.; carboxylic acids such as acrylic acid, methacrylic acid, crotonic acid, cinnamic acid, itaconic acid, maleic acid, citraconic acid, aconitic acid, mesaconic acid, methylenemalonic acid, etc. The terminology “di(meth)acrylate” referred to herein is meant to indicate “diacrylate” and “dimethacrylate”; and the terminology “(meth)acrylic acid” also referred to herein is meant to indicate “acrylic acid” and “methacrylic acid”.

Of the above-mentioned functional groups that are reactive with or have affinity for hydroxyl groups, preferred are acid groups such as carboxyl groups, etc., acid anhydride groups such as those derived from maleic anhydride, and epoxy groups. Especially preferred are acid groups such as carboxyl groups, etc., and epoxy groups. Acid groups such as carboxyl groups, etc. include, for example, those from methacrylic acid and acrylic acid; and epoxy groups include, for example, those from glycidyl methacrylate, glycidyl acrylate, etc.

In forming the multi-layered polymer particles for use herein, the amount of the radical-polymerizable compound to be used, which has a functional group reactive with or having affinity for hydroxyl groups or has a protected functional group of the type, preferably falls between 0.01 and 75% by weight, more preferably between 0.1 and 40% by weight of all the monomers to form the particles. The protected functional group may be any and every one capable of being de-protected to give the free functional group of the type mentioned above, under the condition to be mentioned hereinunder, under which the compound is mixed with EVOH, but this must not interfere with the object of the invention. One example of the protected functional group-having, radical-polymerizable compounds is t-butyl methacrylcarbamate.

In the multi-layered polymer particles having a functional group that is reactive with or has affinity for hydroxyl groups, it is desirable that the functional group is in the molecular chains that constitute the outermost hard layer of the particles. However, so far as the functional group in the multi-layered polymer particles that are combined with EVOH to give a resin composition for use herein can substantially react with the hydroxyl groups in EVOH or can form intermolecular bonds with them, it may in any layer (outermost layer, interlayer, inner layer) of the polymer particles.

Preferably, the rubber layer accounts for from 50 to 90% by weight of the multi-layered polymer particles. If the amount of the polymer moiety to form the rubber layer in the particles is too small, the flexibility of the resin composition comprising the particles is poor. On the other hand, if the amount of the polymer moiety to form the outermost layer in the particles is too small, the particles are difficult to handle.

The method of polymerization to give the multi-layered polymer particles for use in the invention is not specifically defined. For example, spherical multi-layered polymer particles can be produced in ordinary emulsion polymerization. For these, emulsion polymerization can be effected in any ordinary manner generally employed by those skilled in the art If desired, a chain transfer agent such as octylmercaptan, laurylmercaptan or the like may be added to the polymerization system. The multi-layered polymer particles formed through such emulsion polymerization are separated and taken out from the polymer latex in any ordinary manner (for example, through solidification, drying, etc.) generally employed by those skilled in the art.

The mean particle size of the individual multi-layered polymer particles thus formed is not specifically defined. However, particles of which the mean particle size is too small will be difficult to handle; but too large particles will be ineffective for enhancing the impact strength of the coating film of the barrier material (B) comprising them. Accordingly, the mean particle size of the individual multi-layered polymer particles preferably falls between 0.02 and 2 μm, more preferably between 0.05 and 1.0 μm. The shape of the multi-layered polymer particles for use herein is not also specifically defined. For example, the particles may be in any form of pellets, powders, granules and the like where the particles are partly fused or aggregated together at their outermost layer part (these will be hereinafter referred to as aggregated particles). The particles may be completely independent of each other, or may be in the form of such aggregated particles.

In the resin composition for the barrier material (B) that comprises EVOH and multi-layered polymer particles, the condition of the particles dispersed in EVOH is not specifically defined. The multi-layered polymer particles will be uniformly dispersed in EVOH in such a manner that the particles are completely independent of each other in EVOH; or a plurality of multi-layered polymer particles are fused or aggregated together to give aggregated particles, and the aggregated particles will be uniformly dispersed in EVOH; or completely independent particles and aggregated particles will be uniformly dispersed in EVOH. The resin composition for use herein may be in any form of these dispersions. Including the completely independent particles and the aggregated particles, the dispersed, multi-layered polymer particles preferably have a mean particle size of at most 10 μm, more preferably at most 5 μm, even more preferably at most 2 μm. Still more preferably, the particles having a mean particle size of from 0.03 to 1 μm are uniformly dispersed in EVOH. Multi-layered polymer particles having a particle size of larger than 10 μm are difficult to uniformly disperse in the matrix of EVOH. As a result, the impact strength of the coating film of the barrier material (B) of the resin composition containing such large particles is low. The resin composition for the barrier material (B) that comprises EVOH and multi-layered polymer particles may be a dry blend to be prepared by blending in dry a powder of EVOH and the particles However, for ensuring stable morphology of the resin composition that comprises EVOH and multi-layered polymer particles, and for ensuring uniform coats of the barrier material (B), it is desirable that the two components are kneaded in melt.

The invention also relates to a shaped article produced by applying a powder of a barrier material (B), after melting it, to at least a part of the surface of the substrate of the article. One preferred embodiment of the shaped article is a co-extrusion blow-molded container that comprises an interlayer of a barrier resin (D) and inner and outer layers of a polyolefin (A).

The barrier resin (D) for use herein is preferably a thermoplastic resin through which the gasoline permeation amount is 100 g·20 μm/m²·day (measured at 40° C. and 65% RH) and/or the oxygen transmission rate is 100 cc·20 μm/m²·day·atm (measured at 20° C. and 65% RH).

Also preferably, the barrier resin (D) is at least one selected from a group consisting of ethylene-vinyl alcohol copolymers, polyamides and aliphatic polyketones. The ethylene-vinyl alcohol copolymers, polyamides and aliphatic polyketones for the barrier resin (D) may be the same as those for the barrier material (B).

In the co-extrusion blow-molded fuel container of the invention, the polyolefin (A) that forms the inner and outer layers is preferably high-density polyethylene. The high-density polyethylene may be any ordinary commercial product.

In view of its stiffness, impact resistance, moldability, draw-down resistance and gasoline resistance, however, the high-density polyethylene for the layers preferably has a density of from 0.95 to 0.98 g/cm³, more preferably from 0.96 to 0.98 g/cm³. Also preferably, the melt flow rate (MFR) of the high-density polyethylene to form the inner and outer layers of the blow-molded container falls between 0.01 and 0.5 g/10 min (at 190° C. under a load of 2160 g), more preferably between 0.01 and 0.1 g/10 min (at 190° C. under a load of 2160 g).

In case where the barrier resin (D) to form the interlayer of the co-extrusion blow-molded container is EVOH, its ethylene content falls between 5 and 60 mol %. The lowermost limit of the ethylene content of EVOH is preferably at least 15 mol %, more preferably at least 25 mol %. The uppermost limit of the ethylene content thereof is preferably at most 55 mol %, more preferably at most 50 mol %. EVOH having an ethylene content of lower than 5 mol % is unfavorable as its melt moldability is poor. On the other hand, EVOH having an ethylene content of larger than 60 mol % is also unfavorable, as its gasoline barrier properties and oxygen barrier properties are not good. The degree of saponification of the vinyl ester moiety of EVOH for the barrier resin (D) is at least 85%. It is preferably at least 90%, more preferably at least 95%, even more preferably at least 98%, most preferably at least 99%. EVOH having a degree of saponification of smaller than 85% is unfavorable since its gasoline barrier properties and oxygen barrier properties are not good and its thermal stability is poor. In case where the barrier resin (D) to form the interlayer of the co-extrusion blow-molded container is EVOH, its melt flow rate (MFR, measured at 190° C. under a load of 2160 g) preferably falls between 0.01 and 100 g/10 min, more preferably between 0.05 and 50 g/10 min, even more preferably between 0.1 and 10 g/10 min.

An especially important embodiment of the invention is a co-extrusion blow-molded fuel container having an interlayer of a barrier resin (D) and an inner and outer layers of a polyolefin (A), of which the portion having poor barrier properties is coated with a melted powder of a barrier material (B). Concretely, the portion of the container having poor barrier properties includes, for example, the cutting face of the pinch-off part of the container, the cutting face of the opening formed through the body of the container, and the component for the container.

In a more preferred embodiment of the co-extrusion blow-molded fuel container that comprises inner and outer layers of high-density polyethylene and an interlayer of a barrier resin (D), the constituent layers are in the form of a laminate formed by laminating them in that order via an adhesive resin layer of a carboxylic acid-modified polyolefin therebetween. Still more preferably, the fuel container is a gasoline tank for automobiles.

In a blow-molding process for producing plastic containers, a parison formed through melt extrusion is, while being held by a pair of blow molds, pinched off with one pinched-off part being sealed, and the thus pinched-off parison is blown to be a container having a predetermined shape. For large-size containers such as fuel tanks for automobiles, however, the parison held by blow molds is sealed under pressure, but is not pinched off between the molds. For most of such containers, the portion having protruded out of their surface is cut with a cutter or the like so as to have a predetermined height. Of the blow-molded containers, the sealed and bonded portion is a pinch-off part, and the face of the portion having been pinched off between the molds, or the face thereof having been cut with a cutter or the like is the cutting face of the pinch-off part. For its cross section, the pinch-off part protrudes to be thinner in the direction of the thickness of the container wall, and has a tapered form.

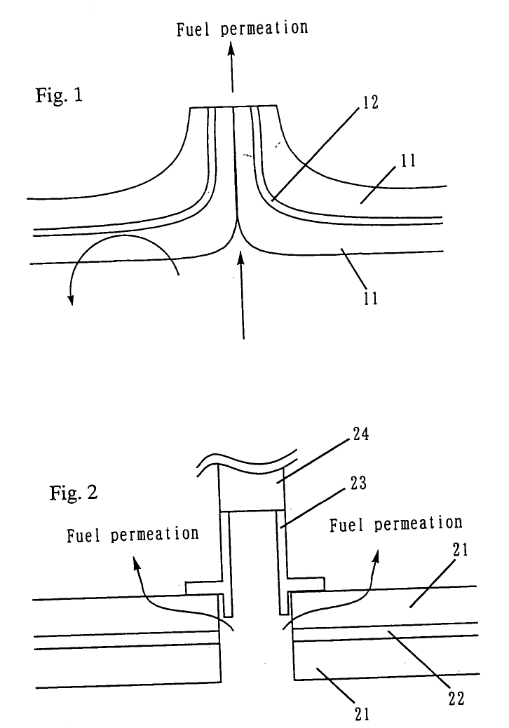

In case where the parison has a multi-layered structure that comprises an interlayer of a barrier resin (D) and inner and outer layers of a polyolefin (A), its blown container could not be satisfactorily resistant to transmission of fuel such as gasoline or the like therethrough. This is because the cutting face of the pinch-off part of the container, or that is, the face of the portion thereof having been pinched off by molds or the face of the portion thereof having been cut with a cutter or the like is not covered with the barrier resin. Concretely referred to is a co-extrusion blow-molded container of a laminate that comprises inner and outer layers 11 of a polyolefin (A) and an interlayer 12 of a barrier resin (D), as in FIG. 1. In case where fuel is in the illustrated container, it passes away through the container at the cutting face of the pinch-off part, precisely, through the layer of the polyolefin (A) existing between the facing layers of the barrier resin (D), as illustrated.

A fuel tank for automobiles is connected with a fuel port, an engine, a canister, etc. via pipes therebetween. Therefore, the body of the tank is formed to have openings therethrough, via which the tank is connected to the pipes, and various components (fuel tank connectors, etc.) for connecting the tank to the pipes are fitted to the tank. In case where the fuel tank for automobiles is a co-extrusion blow-molded container having an interlayer of a barrier resin and an inner and outer layers of a polyolefin, the cutting face of the opening is not covered with the barrier resin. Therefore, fuel in the tank passes away through the tank via the cutting face of the layer existing outside the interlayer of the barrier resin. Concretely, as in FIG. 2, a fuel tank component such as a fuel tank connector 23 is fitted to the opening of the body of a co-extrusion blow-molded container having a laminate structure that comprises inner and outer layers 21 of a polyolefin (A) and an interlayer 22 of a barrier resin (D), and a fuel pipe 24 is fitted to the connector 23. Even though both the connector 23 and the fuel pipe 24 are resistant to fuel transmission through them, fuel still passes away through the tank via the cutting face of the opening of the body of the tank, precisely, via the layer existing outside the layer of the barrier resin (D).

From the above, it is presumed that the gasoline barrier properties of the entire fuel container could be improved by coating the cutting face of the pinch-off part of the container and/or the cutting face of the opening thereof (especially the cutting face of the layer existing outside the interlayer of a barrier resin of the container) with a barrier material. For realizing it, however, there still remain some problems that shall be solved.

One problem is that coating the cutting face of the pinch-off part of a blow-molded container and/or the cutting face of the opening thereof with a barrier material is not always easy. In general, fuel tanks for automobiles are complicated shapes, as they must be efficiently disposed in a limited space. As being such a complicated shape, one fuel tank often has a plurality of pinch-off parts. In addition, one fuel tank generally has a plurality of openings through its body.

To coat the cutting face of the pinch-off part and/or the cutting face of the opening of a fuel container of such a complicated shape with a barrier material, a solution coating method or an emulsion coating method is taken into consideration. However, good solvents are not all the time available for the barrier material for that purpose, and it is often difficult to prepare a solution or emulsion of the barrier material. For these reasons, the barrier material employable for the purpose is limited.

In general, barrier resins having good gasoline barrier properties have a large solubility parameter. Concretely, one good barrier material, EVOH has a solubility parameter (obtained according to the Fedors' formula) is larger than 11. On the other hand, the solubility parameter (obtained according to the Fedors' formula) of high-density polyethylene for the inner and outer layers of co-extrusion blow-molded containers is 6.7. Therefore, the resin affinity between EVOH and high-density polyethylene is low, and in case where the two resins are laminated, they could not enjoy good interlayer adhesion therebetween. For example, in case where EVOH and high-density polyethylene are laminated through co-extrusion, they are generally adhered to each other via an adhesive resin therebetween for preventing interlayer peeling.

Accordingly, in case where the cutting face of the pinch-off part and/or the cutting face of the opening of containers is coated with EVOH in a solution coating or emulsion coating method, it requires complicated primer treatment or adhesive treatment for ensuring sufficient interlayer adhesion strength between the cutting face of polyolefin and the coating layer of EVOH.

Given that situation, we, the present inventors have assiduously studied the problems, and, as a result, have found that, when a powder of a barrier material (B) is, after having been melted, applied to a substrate of a polyolefin (A), then the coating film of the barrier material (B) can firmly adhere to the polyolefin substrate (A) without requiring any specific primer treatment. On the basis of this finding, we have completed the present invention. In one preferred embodiment of the invention, the polyolefin (A) is high-density polyethylene, and the barrier material (B) is EVOH. As so mentioned hereinabove, good interlayer adhesion between EVOH and high-density polyethylene cannot be attained in a solution coating method. Even in a co-extrusion molding method in which different types of resins are melted and layered into laminate structures, good interlayer adhesion between EVOH and high-density polyethylene cannot also be attained. Unexpectedly, however, layers of high-density polyethylene and EVOH can enjoy good interlayer adhesion therebetween only when a powder of EVOH is, after having been melted, applied to the substrate of high-density polyethylene.

The method of applying a powder of a barrier material (B), after melting it, to a substrate of a polyolefin (A) is not specifically defined. For applying a melt of a powdery resin to a substrate, generally employed is any of a flame spray coating process, a rotational molding process, a fluidized bed coating process, an electrostatic coating process, etc. Of these, preferred is a flame spray coating process of applying a powder of a barrier material (B), after melting it, to a substrate of a polyolefin (A), in view of the simplicity in operating the process and of the interlayer adhesion between the polyolefin (A) and the barrier material (B). Though not clear, the reason why the barrier material (B) firmly adheres to the polyolefin substrate (A) when a powder of the barrier material (B) is, after having been melted, applied to the polyolefin substrate (A) according to a flame spray coating process will be because, while a melt of a powdery resin of the barrier material (B) is sprayed over the surface of the polyolefin substrate (A) through a nozzle along with a flame being applied thereover, and is deposited thereon, the surface of the polyolefin substrate (A) is processed with the flame applied thereto, whereby the interlayer adhesion between the polyolefin substrate (A) and the layer of the barrier material (B) formed thereon could be enhanced.

Preferably, the grain size of the powder of the barrier material (B) to be applied to the substrate according to such a flame spray coating process falls between 20 and 100 meshes (JIS K-8801) (that is, the powder passes through a 20-mesh sieve but not through a 100-mesh sieve). More preferably, the grain size falls between 30 and 100 meshes. In case where a large amount of a rough powder not passing through a 20-mesh sieve is used in a flame spray process, it will clog the nozzle and the surface of the coating film will be roughened. That is, a coating film having a smooth surface is difficult to obtain in that case. On the other hand, in case where a large amount of a fine powder passing through a 100-mesh sieve is used in the process, the powder will be readily burnt by the flame applied thereto. In addition, preparing such a fine powder costs a lot.

Though not specifically defined, the thickness of the coating film of the barrier material (B) preferably falls between 1 and 500 μm. The lowermost limit of the thickness of the coating film of the barrier material (B) is more preferably at least 5 μm, even more preferably at least 10 μm. The uppermost limit of the thickness of the coating film of the barrier material (B) is more preferably at most 300 μm, even more preferably at most 250 μm. Coating films of the barrier material (B) having a thickness of smaller than 1 μm will have poor gasoline barrier properties and poor oxygen barrier properties. On the other hand, coating films of the barrier material (B) having a thickness of larger than 500 μm will be readily peeled off from substrates.

From the viewpoint of the adhesion strength of the coating film of the barrier material (B) in the shaped article of the invention, one preferred embodiment of producing the shaped article comprises applying a powder of a carboxylic acid-modified or boronic acid-modified polyolefin to the substrate of a polyolefin (A) according to a flame spray coating process, followed by applying a powder of a barrier material (B) to the resulting carboxylic acid-modified or boronic acid-modified polyolefin layer also according to a flame spray coating process.

The thickness of the carboxylic acid-modified or boronic acid-modified polyolefin layer is not specifically defined so far as it is enough for ensuring good adhesion of the layer to both the polyolefin substrate (A) and the layer of the barrier material (B), but preferably falls between 1 and 500 μm. The lowermost limit of the thickness of the carboxylic acid-modified or boronic acid-modified polyolefin layer is more preferably at least 5 μm, even more preferably at least 10 μm. The uppermost limit of the thickness of the carboxylic acid-modified or boronic acid-modified polyolefin layer is more preferably at most 250 μm, even more preferably at most 100 μm. If its thickness is smaller than 1 μm, the carboxylic acid-modified or boronic acid-modified polyolefin layer could not satisfactorily exhibit its function as an adhesive between the polyolefin (A) and the barrier material (B). On the other hand, if its thickness is larger than 500 μm, the layer will easily peel off from the substrate. From the viewpoint of the gasoline barrier properties and the oxygen barrier properties of the shaped article to be obtained herein, the step of applying a powder of the barrier material (B), after melting it, to the carboxylic acid-modified or boronic acid-modified polyolefin layer is preferably so effected that the carboxylic acid-modified or boronic acid-modified polyolefin layer is, without being exposed outside, covered with the layer of the barrier material (B).

On the other hand, from the viewpoint of the impact strength of the coating film of the barrier material (B) in the shaped article of the invention, the shaped article is produced in another preferred embodiment that comprises applying a powder of a barrier material (B), after melting it, to the substrate of a polyolefin (A), followed by applying a powder of a thermoplastic resin (C) having an elastic modulus at 20° C. of at most 500 kg/cm², after melting it, to the resulting layer of the barrier material (B). Similarly, for improving the impact strength of the coating film of the barrier material (B) in the shaped article of the invention, also preferred is still another embodiment that comprises applying a powder of a thermoplastic resin (C) having an elastic modulus at 20° C. of at most 500 kg/cm², after melting it, to the substrate of a polyolefin (A), followed by applying a powder of a barrier material (B), after melting it, to the resulting layer of the thermoplastic resin (C). In these embodiments, the powder of a barrier material (B) and the powder of a thermoplastic resin (C) are preferably applied to the polyolefin substrate (A) according to a flame spray coating process.

The thickness of the layer of the thermoplastic resin (C) is not specifically defined, but preferably falls between 1 and 500 μm. The lowermost limit of the thickness of the layer of the thermoplastic resin (C) is more preferably at least 5 μm, even more preferably at least 10 μm. The uppermost limit of the thickness of the layer of the thermoplastic resin (C) is more preferably at most 250 μm, even more preferably at most 100 μm. If the thickness of the layer of the thermoplastic resin (C) is smaller than 1 μm, the effect of the layer for improving the impact resistance of the layer of the barrier material (B) will be poor; but if larger than 500 μm, the layer will easily peel off. From the viewpoint of the gasoline barrier properties and the oxygen barrier properties of the shaped article to be obtained herein, the step of applying a powder of the barrier material (B), after melting it, to the layer of the thermoplastic resin (C) is preferably so effected that the layer (C) is, without being exposed outside, covered with the layer of the barrier material (B).

The invention relates to a shaped article produced by applying a powder of a barrier material (B)₁ after melting it, to at least a part of the surface of a substrate of a polyolefin (A). The invention is especially effective for the shaped article produced through injection molding. According to the invention, even the shaped article of such a complicated shape can be coated with a barrier material (B) to have barrier properties. To this effect, the meaning of the invention is significant. Preferred examples of the shaped article produced through injection molding are a head of a tubular container, and a component for fuel containers.

The component for fuel containers is a member to be attached to fuel containers, including, for example, connectors for fuel containers, caps for fuel containers, release valves for fuel containers, etc. However, these are not limitative. The component for fuel containers may have a single-layered structure, or may have a multi-layered structure that comprises a layer of a polyolefin (A) and a barrier layer of a barrier resin (D).

One preferred embodiment of the connector for fuel containers is such that a flexible pipe for fuel transportation is fitted to the connector that is fitted to the body of a fuel tank, but this is not limitative. For fitting the connector to the body of a fuel tank, for example, employable is any method of screwing, embedding, heat sealing, etc. Preferred is heat sealing, as its process is simple and the heat-sealed portion is resistant to fuel leak.

The cap for fuel containers is a member for closing fuel ports. The method of fitting the cap to a fuel container is not specifically defined, including, for example, screwing, embedding, etc. Preferred is screwing. At present, many caps for fuel containers are made of metal. However, thermoplastic resin caps are being popularized these days, as being lightweight and recyclable. A fuel port is connected to the body of a fuel tank via a fuel pipe and a connector therebetween. Heretofore, metal caps for fuel containers are said to be problematic in that metal oxides from rusted metal caps contaminate fuel in tanks. To that effect, the meaning of thermoplastic resin-caps is great.

For making a fuel container component of a polyolefin (A) have barrier properties, the component is attached to the body of a fuel container, and then a powder of a barrier material (B) is, after having been melted, applied thereto; or a powder of a barrier material (B) is, after having been melted, applied to the component, and then the thus-coated component is attached to the body of a fuel container. In the latter case, the component is preferably heat-sealed to the body of a fuel container. In one preferred embodiment for the case, the area except the heat-sealed portion is coated with the barrier material (B).

The multi-layered shaped article of the invention, which is obtained by applying a powder of a barrier material (B), after melting it, to a substrate of a polyolefin (A), is favorable to fuel pipes and floor heating pipes. Fuel pipes are usable not only as those for automobiles but also as fuel lines for transporting fuel from oil fields. A plurality of such fuel pipes are often connected to each other via connectors therebetween. The connectors are complicated shapes (preferably, these are produced in a process of injection molding), and are required to have gasoline barrier properties and/or oxygen barrier properties. Therefore, the multi-layered shaped article of the invention is favorable to the connectors.

The fuel pipes and the floor heating pipes are preferably multi-layered pipes of a laminate that comprises an interlayer of a barrier resin (D) and inner and outer layers of a polyolefin (A). For connecting such multi-layered pipes to each other via connectors therebetween, often employed is a process of first expanding the diameter of the edges of each pipe by means of a specific expanding tool, in which the step of expanding the diameter is effected gradually and several times. In the process, the barrier resin (D) is often cracked in the portion of the expanded multi-layered pipe. In particular, in case where such multi-layered pipes are worked in the environment in which the outside air temperature is extremely low, for example, in the district where floor heaters are installed, the layer of the barrier resin (D) is often seriously cracked. The cracks detract from the gasoline barrier properties and/or the oxygen barrier properties of the bonded portion of the multi-layered pipes.

However, by applying a powder of a barrier material (B), after melting it, to the expanded portion of the multi-layered pipes, the gasoline barrier properties and/or the oxygen barrier properties of the bonded portion of the pipes can be significantly enhanced.

### EXAMPLES

The invention is described in more detail with reference to the following Examples, which, however, are not intended to restrict the scope of the invention.

(1-1) Evaluation of the Fuel Permeation Amount of the Barrier Material (B):

A specimen of a layered product including a layer of barrier material (B) was prepared as explained below, the fuel permeation amount of this layered product was determined, and converted into the permeation amount of barrier material (B) of a predetermined thickness.

The high-density polyethylene (HDPE) BA-46-055 (having a density of 0.970 g/cm³, and a MFR of 0.03 g/10 min at 190° C. and 2160 g) by Paxon was used; for the adhesive resin, ADMER GT-6A (having a MFR of 0.94 g/10 min at 190° C. and 2160 g) by Mitsui Chemicals, Inc. was used. A barrier material (B) to be tested, the high-density polyethylene and the adhesive resin were given into separate extruders, and a coextrusion sheet with a total thickness of 120 μm having the structure high-density polyethylene/adhesive resin/barrier material (B)/adhesive resin/high-density polyethylene (film thickness 50 μm/5 μm/10 μm/5 μm/50 μm) was obtained by extrusion molding. In the above coextrusion sheet molding, the high-density polyethylene was extruded from an extruder (barrel temperature: 170 to 210° C.) having a uniaxial screw of 65 mm diameter and L/D=24, the adhesive resin was extruded from an extruder (barrel temperature: 160 to 210° C.) having a uniaxial screw of 40 mm diameter and L/D=22, and the barrier material (B) was extruded from an extruder (barrel temperature: 170 to 210° C.) having a uniaxial screw of 40 mm diameter and L/D=22 into a feed-block-type die (600 mm width and temperature adjusted to 210° C.) to obtain a coextrusion sheet (a1).

One side of the coextrusion sheet (a1) was covered with aluminum adhesive tape (product by FP Corp., trade name “Alumi-seal”; fuel permeation amount of 0 g·20 μm/m²·day), thereby obtaining the aluminum-covered sheet (b1).

Both the coextrusion sheet (a1) and the aluminum-covered sheet (b1) were cut into pieces of 210 mm×300 mm size. Then these pieces were folded in the middle so their size became 210 mm×150 mm, and using the Heat Sealer T-230 by Fuji Impulse Co., pouches were prepared by heat-sealing of any two sides with dial 6 so that the seal width becomes 10 mm. Thus, pouches (a2) made of the coextrusion sheet only and aluminum-covered pouches (b2) were obtained. The aluminum-covered pouches (b2) were made so that the aluminum layer was on the outside.

Then, 200 ml of Ref. fuel C (toluene/isooctane=1/1) was filled as model gasoline into the pouches through the opening portions, and then the pouches were heat-sealed with a sealing width of 10 mm by the afore-mentioned method.

The pouches, filled with gasoline, were shelved in an explosion-proof thermo-hygrostat chamber (at 40° C. and 65% RH), and the weight of the pouches was measured every seven days over a period of three months. This experiment was carried out on five each of the coextrusion sheet pouches (a2) and the aluminum-covered pouches (b2). The weight of the pouches before and during the shelf-test was measured, and the gasoline permeation amount (fuel permeation amount) was calculated from the slope of a curve prepared according to the weight change of the pouches over the shelf time.

The fuel permeation amount of the pouches (a2) made only of the coextrusion sheet corresponds to the sum of the permeation amount through the pouch surface and through the heat-sealing-portions, whereas the fuel permeation amount of the aluminum-covered pouches (b2) corresponds to the permeation amount through the heat-sealing portions.
{fuel permeation amount through (a2)}−{fuel permeation amount through (b2)} was taken as the fuel permeation amount per 10 μm of the barrier material (B). Converting this into the permeation amount per 20 μm of a barrier material (B) layer, the resulting value was taken as the fuel permeation amount (g·20 μm/m²·day) of the barrier material (B).
   (1-2) Evaluation of the Fuel Permeation Amount of Polyolefin (A):

Toyo Seiki's Laboplastomil equipped with a single screw having a diameter of 20 mm and L/D of 22 was used. Through its coathanger die having a width of 300 mm, a polyolefin (A) was extruded out at a temperature higher by 20° C. than its melting point to prepare a 100 μm sheet. The sheet was cut into a size of 210 mm×300 mm.

Then these pieces were folded in the middle so their size became 210 mm×150 mm, and using the Heat Sealer T-230 by Fuji Impulse Co., pouches were prepared by heat-sealing of any two sides with dial 6 so that the seal width becomes 10 mm.

Then, 200 ml of Ref. fuel C (toluene/isooctane=1/1) was filled as model gasoline into the resulting pouches through the opening portions, and then the pouches were heat-sealed with a sealing width of 10 mm by the aforementioned method.

The pouches, filled with gasoline, were shelved in an explosion-proof thermo-hygrostat chamber (at 40° C. and 65% RH), and the weight of the pouches was measured every six hours over a period of three days. This experiment was carried out on five pouches. The weight of the pouches before and during the shelf-test was measured, and the gasoline permeation amount (fuel permeation amount) was calculated from the slope of a curve prepared according to the weight change of the pouches over the shelf time. By thickness conversion, the permeation amount (g·20 μm/m²·day) was calculated.

(1-3) Evaluation of the Fuel Permeation Amount of the Barrier Resin (C):

The fuel permeation amount was measured using the same method as for the barrier material (B).

(2) Measurement of Oxygen Barrier Properties of Barrier Material (B):

Toyo Seiki's Laboplastomil equipped with a single screw having a diameter of 20 mm and L/D of 22 was used. Through its coathanger die having a width of 300 mm, a barrier material (B) was extruded out at a temperature higher by 20° C. than its melting point to prepare a 25 μm film. Using an oxygen transmission rate measuring device, Modern Control's Ox-Tran-100, the oxygen transmission rate through the film was measured at 20° C. and 65% RH. The data obtained are given in Table 1.

TABLE 1
List of Barrier Materials

| | | Fuel | Oxygen |
|---|---|---|---|
| | | permeation | Transmission |
| | | amount*1 | Rate*2 |
| b-1 | EVOH having an ethylene | — | 3.2 |
| | content of 48 mol %, a degree | | |
| | of saponification of 99.6%, | | |
| | and MFR of 13.1 g/10 min (at | | |
| | 190° C. under a load of 2160 g) | | |
| b-2 | EVOH having an ethylene | 0.003 | 0.4 |
| | content of 32 mol %, a degree | | |
| | of saponification of 99.5%, | | |
| | and MFR of 4.6 g/10 min (at | | |
| | 190° C. under a load of 2160 g) | | |
| b-3 | Ube Kosan's Nylon 3014U | 30 | 200 |
| b-4 | (b-1)/boronic acid-modified | — | 3.6 |
| | polyethylene produced in | | |
| | Synthesis Example 1 = 90/10% | | |
| | by weight | | |
| b-5 | (b-1)/multi-layered polymer | — | 3.5 |
| | particles produced in | | |
| | Synthesis Example 2 = 90/10% | | |
| | by weight | | |

*1g · 20 μm/m² · day · atm
*2cc · 20 μm/m² · day

### EXAMPLE 1

Polyethylene having MFR of 0.3 g/10 min (at 190° C. under a load of 2160 g) and a density of 0.952 (hereinafter referred to as HDPE) was injection-molded into pieces having a size of 10 cm×10 cm and a thickness of 1 mm. On the other hand, a barrier material (B) of pellets (b-1) {EVOH having an ethylene content of 48 mol %; a degree of saponification of 99.6%, and MFR of 13.1 g/10 min (at 190° C. under a load of 2160 g)) was powdered in a low-temperature mill (in which was used liquid nitrogen). The resulting powder was sieved, and its fraction having passed through a 40-mesh sieve but not through a 100-mesh sieve was collected. The resulting barrier material powder (b-1) was sprayed on one surface of the injection-molded piece according to a flame spray coating process, and then left cooled in air. The thickness of the coating layer was 50 μm.

(3) Measurement of Oxygen Transmission Rate Through Sheet:

The injection-molded piece of HDPE that had been coated with a powder of the barrier material (B) was set in an oxygen transmission rate measuring device, Modern Control's Ox-Tran-100, in such a manner that its surface coated with the barrier material (B) could be exposed to oxygen therein. Being thus set in the device, the oxygen transmission rate through the test piece was measured at 20° C. and 65% RH. It is given in Table 2.

(4) Impact Strength:

The injection-molded piece of HDPE that had been coated with a powder of the barrier material (B) was subjected to a dart impact test according to JIS K-7124. The total of the dart and the weight used in the test was 320 g. The height for the test was 150 cm. The sample piece was so set in the tester that the dart could be shot nearly at the center of its surface coated with the barrier material (B). After the dart impact test, the condition of the coating film of the barrier material (B) of the tested sample piece was macroscopically checked as to how and to what degree the coating film was damaged by the dart. According to the criteria mentioned below, the tested sample piece was evaluated for its impact resistance and adhesiveness. The test results are given in Table 2.
Impact Resistance:
   A: Not cracked.
   B: Slightly cracked.
   C: Cracked a little in and around the dart-shot portion.
   C: Cracked over the surface.
Adhesiveness:
   A: The barrier material (B) did not peel.
   B: Partly peeled in and around the dart-shot portion.
   C: Peeled over the surface.

### EXAMPLE 2

Another barrier material (B) of (b-2) {EVOH having an ethylene content of 32 mol %, a degree of saponification of 99.5%, and MFR of 4.6 g/10 min (at 190° C. under a load of 2160 g)} was tested and evaluated in the same manner as in Example 1. The test results are given in Table 2.

### EXAMPLE 3

Another barrier material (B) of (b-3) {Ube Kosan's nylon-12, Nylon 3014U} was tested and evaluated in the same manner as in Example 1. The test results are given in Table 2.

### EXAMPLE 4

Polyethylene having MFR of 0.3 g/10 min (at 190° C. under a load of 2160 g) and a density of 0.952 was injection-molded into pieces having a size of 10 cm×10 cm and a thickness of 1 mm. One surface of each piece was sprayed with a powder of ethylene-methacrylic acid copolymer (hereinafter referred to as EMAA) (Mitsui DuPont Polychemical's Nucrel 0903HC, having a methacrylic acid (MAA) content of 9% by weight and having MFR of 5.7 g/10 min (at 210° C. under a load of 2160 g)—this was powdered in the same manner as in Example 1} according to a flame spray coating process. The thickness of the coating layer was 50 μm. Next, the barrier material (b-1) having been powdered in the same manner as in Example 1 was sprayed on the coating film of EMMA also according to a flame spray coating process. Its thickness was 50 μm. The injection-molded pieces of HDPE that had been thus coated with a powder of EMAA and a powder of the barrier material (B) were tested and evaluated in the same manner as in Example 1. The test results are given in Table 2.

### EXAMPLE 5

An ethylene-propylene copolymer (hereinafter referred to as EPR; Mitsui Chemical's Tafiner P0280 having an elastic modulus of smaller than 500 kg/cm²—this was powdered in the same manner as in Example 1) was sprayed on the coating film of the barrier material (b-1) of the injection-molded pieces of HDPE produced in Example 1 (these were coated with a 50 μm layer of the barrier material (b-1)) according to a flame spray coating process. The thickness of the coating film of EPR was 50 am. The injection-molded pieces of HDPE that had been thus coated with a powder of the barrier material (B) and a powder of EPR were tested and evaluated in the same manner as in Example 1. The test results are given in Table 2.

### SYNTHESIS EXAMPLE 1

1000 g of very-low-density polyethylene (MFR, 7 g/10 min (at 210° C. under a load of 2160 g); density, 0.89 g/cm³; terminal double bond content, 0.048 meq/g) and 2500 g of decalin were put into a separable flask equipped with a condenser, a stirrer and a dropping funnel, then degassed at room temperature under reduced pressure, and thereafter purged with nitrogen. To this were added 78 g of trimethyl borate and 5.8 g of borane-triethylamine complex, and reacted at 200° C. for 4 hours. Next, an evaporator was fitted to the flask, and 100 ml of methanol was gradually dripped thereinto. After methanol was thus added thereto, the system was evaporated under reduced pressure to remove low-boiling-point impurities such as methanol, trimethyl borate and triethylamine from it. Next, 31 g of ethylene glycol was added to the system, and stirred for 10 minutes. Acetone was added thereto for re-precipitation, and the deposit was taken out and dried. The product thus obtained is boronic acid-modified very-low-density polyethylene having an ethylene glycol boronate content of 0.027 meq/g and having MFR of 5 g/10 min (at 210° C. under a load of 2160 g).

### EXAMPLE 6

10 parts by weight of the boronic acid-modified very-low-density polyethylene that had been prepared in Synthesis Example 1, and 90 parts by weight of a barrier material (b-1) were put into a double-screw vent extruder, and extruded out for pelletization in the presence of nitrogen at 220° C. The pellets are of a barrier material (b-4). These were powdered in the same manner as in Example 1.

The barrier material (B) of a powder of the barrier material (b-4) that had been prepared herein was tested and evaluated in the same manner as in Example 1. The test results are given in Table 2.

### SYNTHESIS EXAMPLE 2

600 parts by weight of distilled water, and 0.136 parts by weight of sodium laurylsarcosinate and 1.7 parts by weight of sodium stearate both serving as an emulsifier were put into a polymerization reactor equipped with a stirrer, a condenser and a dropping funnel, in a nitrogen atmosphere, and dissolved under heat at 70° C. into a uniform solution. Next, at the same temperature, 100 parts by weight of butyl acrylate, 60 parts by weight of ethyl acrylate, and 2.0 parts by weight of a poly-functional polymerizable monomer, allyl methacrylate were added thereto, and stirred for 30 minutes. Then, 0.15 parts by weight of potassium peroxo-disulfate was added thereto to start polymerization. After 4 hours, it was confirmed through gas chromatography that all monomers were consumed.

Next, 0.3 part by weight of potassium peroxo-disulfate was added to the resulting copolymer latex, and thereafter a mixture of 60 parts by weight of methyl methacrylate, 20 parts by weight of methacrylic acid, and 0.1 part by weight of n-octylmercaptan serving as a chain transfer agent was dropwise added thereto through the dropping funnel over a period of 2 hours. After the addition, this was further reacted at 70° C. for 30 minutes. After it was confirmed that all monomers were confirmed, the polymerization was finished. The latex thus obtained had a mean particle size of 0.20 μm. This was cooled at −20° C. for 24 hours for coagulation, and the thus-coagulated solid was taken out and washed three times with hot water at 80° C. Next, this was dried under reduced pressure at 50° C. for 2 days. The product is a latex of two-layered polymer particles having an inner layer of acrylic rubber of essentially butyl acrylate (Tg=−44° C.) and an outermost hard layer of methyl methacrylate and methacrylic acid (Tg=128° C.). The particle size of the multi-layered polymer particles in the thus-prepared latex was measured according to a dynamic light scattering process using a laser particle size analyzer system, PAR-III (from Otuka Electronics). As a result, the mean particle size of the multi-layered polymer particles was 0.20 μm.

### EXAMPLE 7

10 parts by weight of the above-mentioned multi-layered polymer particles, and 90 parts by weight of a barrier material (b-1) were put into a double-screw vent extruder, and extruded out for pelletization in the presence of nitrogen at 220° C. The pellets are of a barrier material (b-5). These were powdered in the same manner as in Example 1. The barrier material (B) of a powder of the barrier material (b-5) that had been prepared herein was tested and evaluated in the same manner as in Example 1. The test results are given in Table 2.

### COMPARATIVE EXAMPLE 1

Polyethylene having MFR of 0.3 g/10 min (at 190° C. under a load of 2160 g) and a density of 0.952 was injection-molded into pieces having a size of 10 cm×10 cm and a thickness of 1 mm. The oxygen transmission rate through the piece was 50 cc/m²·day·atm.

### COMPARATIVE EXAMPLE 2

A barrier material (b-1) was dissolved in a mixed solvent of water/isopropyl alcohol=35 parts by weight/65 parts by weight, under heat at 80° C. to prepare an EVOH solution, in which the amount of the barrier material EVOH was 10 parts by weight.

One surface of an injection-molded piece (10 cm×10 cm in size, 1 mm in thickness) of polyethylene (having MFR of 0.3 g/10 min at 190° C. under a load of 2160 g, and a density of 0.952) that had been prepared in the same manner as in Example 1 was coated with the EVOH solution according to a solution coating process. The coating film of EVOH had a mean thickness of 20 μm. The thus EVOH-coated, injection-molded piece was immediately dried in a hot air drier at 80° C. for 5 minutes, but the coating film of the barrier material (b-2) peeled off while the piece was dried.

TABLE 2

| | Oxygen | | |
|---|---|---|---|
| | Transmission | Impact | Adhesion |
| | Rate*3 | Strength | Strength |
| Example 1 | 1.2 | B | B |
| Example 2 | 0.2 | C | B |
| Example 3 | 31 | B | B |
| Example 4 | 1.2 | A | A |
| Example 5 | 1.2 | A | B |
| Example 6 | 1.5 | A | B |
| Example 7 | 1.4 | A | B |
| Comp. Example 1 | 50 | — | — |

*3cc/m² · day · atm

As in the above, the shaped articles of Examples 1 to 7 of the invention, which had been produced by applying a powder of a barrier material (B), after melting it, to a substrate of a polyolefin (A) all had good oxygen barrier properties. Though the substrate of a polyolefin (A) of these shaped articles was not subjected to any special primer treatment, the coating film of the barrier material (B) formed on the substrate had good interlayer adhesiveness to the substrate.

In the multi-layered shaped article of Example 6, for which the barrier material (B) used was a resin composition comprising 90% by weight of EVOH and 10% by weight of a boronic acid-modified polyolefin, and in the multi-layered shaped article of Example 7, for which the barrier material (B) used was a resin composition comprising 90% by weight of EVOH and 10% by weight of multi-layered polymer particles, the impact strength of the coating film of the barrier material (B) was higher than that in the shaped article of Example 1.

In the multi-layered shaped article of Example 5, which had been produced by applying a powder of a barrier material (b-1) to an injection-molded piece of high-density polyethylene according to a flame spray coating process, followed by applying a powder of EPR to the resulting layer of the barrier material (b-1) also according to a flame spray coating process, the impact strength of the coating film of the barrier material (B) was improved.

In the multi-layered shaped article of Example 4, which had been produced by applying a powder of EMAA to an injection-molded piece of high-density polyethylene according to a flame spray coating process, followed by applying a powder of a barrier material (b-1) to the resulting EMAA layer also according to a flame spray coating process, the impact strength and also the adhesiveness of the coating film of the barrier material (b-1) were both improved.

As opposed to these, however, in the shaped article of Comparative Example 2, which had been produced by applying a solution of a barrier material (b-1) to an injection-molded piece of high-density polyethylene according to a solution coating process, the barrier material (b-1) did not adhere at all to the high-density polyethylene. Accordingly, the injection-molded piece processed in Comparative Example 2 did not have barrier properties.

### EXAMPLE 8

Paxon's BA46-055 (this is high-density polyethylene, HDPE, having a density of 0.970, and MFR at 190° C. under a load of 2160 g of 0.03 g/10 min, and the gasoline permeation amount through it is 4000 g·20 μm/m²·day); Mitsui Chemical's ADMERGT-6A serving as an adhesive resin (Tie) (this has MFR at 190° C. under a load of 2160 g of 0.94 g/10 min); and a barrier resin (C), ethylene-vinyl alcohol copolymer having an ethylene content of 32 mol %, a degree of saponification of 99.5 mol %, and MFR at 190° Cunder a load of 2160 g of 1.3 g/10 min (the gasoline permeation amount through it is 0.003 g·20 μm/m²·day) were blow-molded by the use of a Suzuki Tekkojo's blow-molding machine, TB-ST-6P. Precisely, these resins were first extruded out at 210° C. into a three-resin, five-layered parison of (inner side) HDPE/Tie/Barrier/Tie/HDPE (outer side), and the parison was blown in a mold at 15° C., and then cooled for 20 seconds to be a 35-liter tank of (outer side) HDPE/adhesive resin/EVOH(C)/adhesive resin/HDPE (inner side)=2500/100/150/100/2500 (μm) having an overall wall thickness of 5250 μm. The pinch-off part of the tank had a length of 920 mm, a width of 5 mm and a height of 5 mm. A powder of a barrier material (b-1) that had been powdered in the same manner as in Example 1 was sprayed on the pinch-off part of the fuel tank according to a flame spray coating process, and then left cooled in air. The thickness of the coating film layer of the barrier material (b-1) was 50 μm, and the barrier material layer spread over the range of 25 mm around the pinch-off part. The surface of the resulting shaped article was glossy and smooth. The fuel transmission rate through the pinch-off part of the fuel tank, and the impact strength of the fuel tank were measured. The data obtained are given in Table 3.

(5) Fuel Permeation Amount of the Pinch-Off Part of Tank:

Except its pinch-off part, the shaped article, 35-liter tank was coated with a film of polyethylene 60 μm/aluminium foil 12 μm/polyethylene 60 μm, through heat lamination with ironing at 170° C. The coating film is for preventing gasoline permeation through the area except the pinch-off part of the tank. 30 liters of model gasoline, Ref. C (toluene/isooctane=50/50% by volume) was put into the tank through its mouth (this served as a blowing mouth while the tank was produced by blow molding), and the mouth was then sealed with an aluminium tape (FP Kako's commercial product of Alumiseal—this is resistant to gasoline permeation therethrough, having a gasoline permeation amount of 0 g·20 μm/m²·day). The tank with gasoline therein was left at 4⁰° C. and 65% RH for 3 months. Three 35-liter tanks of the same type were tested in that manner, and the weight change of each tank before and after the test was obtained. The average of the data obtained indicates the fuel permeation amount through the pinch-off part of the tank.

(6) Drop and Impact Test:

30 liters of water was put into the tank of which the pinch-off part had been coated with a barrier material (B), and the mouth of the tank was sealed with an aluminium tape (FP Kako's commercial product of Alumiseal—this is resistant to gasoline permeation therethrough, having a gasoline permeation amount of 0 g·20 μm/m²·day). The tank was dropped down from a height of 10 m with its pinch-off part being prevented from colliding against the ground. After having been thus dropped down, the pinch-off part of the tank was checked for its condition.
Impact Resistance:
   A: No change found in the coating film of the barrier material (B) on the pinch-off part.
   B: The coating film of the barrier material (B) on the pinch-off part cracked only slightly.
   C: The coating film of the barrier material (B) on the pinch-off part partly cracked and peeled.
   D: The coating film of the barrier material (B) on the pinch-off part cracked and peeled over it.

### EXAMPLE 9

A fuel tank was produced in the same manner as in Example 8, of which, however, the pinch-off part was coated with a barrier material (B), (b-2). This was tested and evaluated in the same manner as in Example 8. The test results are given in Table 3.

### EXAMPLE 10

The same fuel tank as in Example 8 was processed as follows: A powder of EMAA (Mitsui DuPont Polychemical's Nucrel 0903HC, having a methacrylic acid (MAA) content of 9% by weight and having MFR of 5.7 g/10 min (at 210° C. under a load of 2160 g)) was sprayed on the pinch-off part of the tank, according to a flame spray coating process as in Example 4. The thickness of the coating layer was 50 μm. The coating layer spread over the range of 20 mm around the pinch-off part. Next, the same barrier material (b-1) as in Example 8 was sprayed on the thus-coated pinch-off part in the same manner as in Example 8. The thickness of the barrier layer coated was 50 μm. The barrier layer spread over the range of 25 mm around the pinch-off part. The thus-processed tank was tested and evaluated in the same manner as in Example 8. The test results are given in Table 3.

### EXAMPLE 11

A fuel tank was produced in the same manner as in Example 8, of which, however, the pinch-off part was coated with a barrier material (B), (b-3). This was tested and evaluated in the same manner as in Example 8. The test results are given in Table 3.

### COMPARATIVE EXAMPLE 3

A fuel tank was produced in the same manner as in Example 8, of which, however, the pinch-off part was not coated with a barrier material (B). The fuel transmission rate through the pinch-off part of the fuel tank was measured. The data obtained are given in Table 3.

TABLE 3

| | Gasoline permeation | |
|---|---|---|
| | amount | Drop and Impact Test |
| Example 8 | <0.01 g/3 months | B |
| Example 9 | <0.01 g/3 months | B |
| Example 10 | <0.01 g/3 months | A |
| Example 11 | <0.01 g/3 months | A |
| Comparative Example 3 | 0.06 g/3 months | — |

### EXAMPLE 12

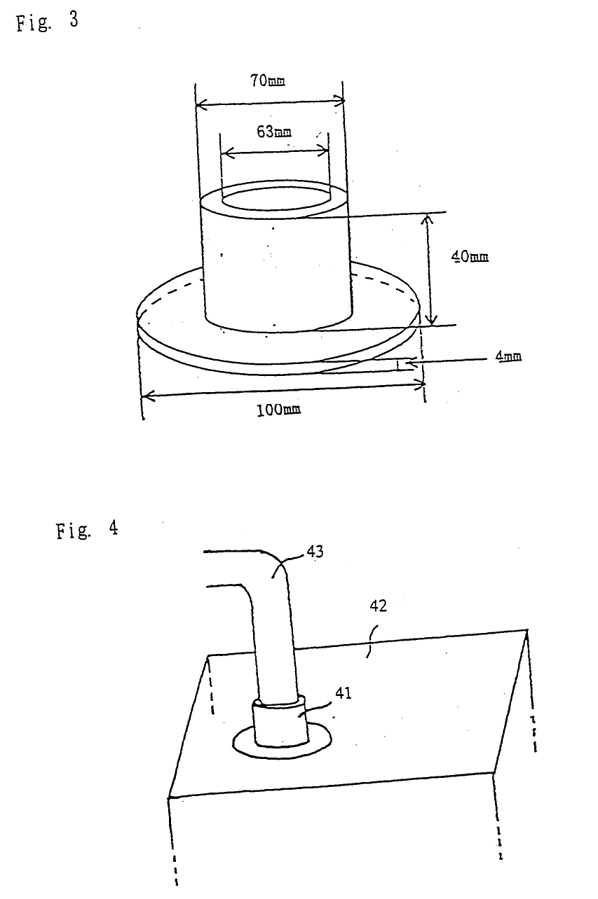

Polyethylene having MFR of 0.3 g/10 min (at 190° C. under a load of 2160 g) and a density of 0.952 was fed into an injection-molding machine, and formed into a cylindrical single-layered article (FIG. 3) having an inner diameter of 63 mm, an outer diameter of 70 mm and a height of 40 mm. The shaped article is like a connector for fuel tanks (this is hereinafter referred to as a connector-like article. As in FIG. 4, the connector-like article 41 is fitted to the body 42 of a tank, and a pipe 43 is fitted into the head of the connector-like article 1.

On the other hand, an opening having a diameter of 50 mm was formed through the body of the multi-layered fuel tank produced in Example 8 (the pinch-off part of the tank was coated with a powdery barrier material (b-1)). Both the area around the hole of the tank and the connector-like article produced herein were fused with a hot iron plate at 250° C. for 40 seconds, and these were heat-sealed under pressure. Thus was produced a multi-layered tank with one connector-like article fitted thereto.

The entire outer surface except the top surface of the head (that is, the flat top surface of the ring having an outer diameter of 70 mm and an inner diameter of 63 mm) of the connector-like article having been fitted into the fuel tank was coated with a powder of a barrier material (b-1) which had been powdered in the same manner as in Example 1, according to a flame spray coating process. The thickness of the barrier layer was 50 μm.

The gasoline permeation amount through the area of the connector-like article fitted into the fuel tank was measured. The data obtained are given in Table 4.

(7) Measurement of Gasoline Permeation Amount Through Connector-Like Article:

30 liters of model gasoline (toluene/isooctane=5.0/50% by volume) was put into the fuel tank produced herein with a connector-like article being fitted thereto, through its mouth (this served as a blowing mouth while the tank was produced by blow molding), and the mouth was then sealed with an aluminium tape (FP Kako's commercial product of Alumiseal—this is resistant to gasoline permeation therethrough, having a gasoline permeation amount of 0 g·20 μm/m²·day). Next, an aluminium disc having a diameter of 80 mm and a thickness of 0.5 mm was firmly fitted to the top surface of the connector-like article not coated with the powdery barrier material (b-1) by the use of an epoxy adhesive. The thus-fabricated fuel tank with gasoline therein was kept in an explosion-proof thermo-hygrostat (40° C., 65% RH) for 3 months. Three 35-liter tanks of the same type were tested in the same manner, and the data of the weight change (W) of the tanks before and after the storage test were averaged.

Three control tanks were prepared. Each control tank was so fabricated that one hole formed through its body was heat-sealed with a multi-layered sheet (HDPE/adhesive resin/EVOH/adhesive resin/HDPE=2100/100/600/100/200 μm—for this, used were the same resins as those used in preparing the multi-layered tank), and not with the connector-like article. In this, the 200 μm HDPE layer of the heat-sealed sheet faced the body of the tank. These control tanks with gasoline therein were kept in the same explosion-proof thermo-hygrostat chamber (40° C., 65% RH) for 3 months in the same manner as herein. The data of the weight change (w) of the control tanks before and after the storage test were averaged.

The gasoline permeation amount through the connector is obtained according to the following equation (1):
Gasoline permeation amount through connector=W−w

### EXAMPLE 13

A multi-layered tank with one connector-like article fitted thereto was produced in the same manner as in Example 12. In this, however, the outer surface except the top surface of the head of the connector-like article fitted into the tank was coated with a barrier material (B) in the manner as follows: First, it was sprayed with a powder of EMAA (Mitsui DuPont Polychemical's Nucrel 0903HC, having a methacrylic acid (MAA) content of 9% by weight and having MFR of 5.7 g/10 min (at 210° C. under a load of 2160 g)—this was powdered in the same manner as in Example 1) according to a flame spray coating process. The thickness of the coating layer was 50 μm. Next, the entire outer surface except the top surface of the head (that is, the flat top surface of the ring having an outer diameter of 70 mm and an inner diameter of 63 mm) of the thus EMMA-coated, connector-like article fitted into the tank was further coated with a powder of a barrier material (b-1) that had been powdered in the same manner as in Example 1, according to a flame spray coating process, in such a manner that the underlying EMMA layer was not exposed outside. The gasoline permeation amount through the area of the connector-like article fitted into the fuel tank, in which the connector-like article was coated with the barrier material (b-1) and with EMMA, was measured in the same manner as in Example 12. The data obtained are given in Table 4.

### COMPARATIVE EXAMPLE 4

The gasoline permeation amount through the area of the connector-like article fitted into the fuel tank was measured in the same manner as in Example 12. In this, however, the connector-like article was not coated with the barrier material (B). The data obtained are given in Table 4.

TABLE 4

| | Gasoline permeation amount |
|---|---|
| Example 12 | <0.01 g/3 months |
| Example 13 | <0.01 g/3 months |
| Comparative Example 4 | 6.3 g/3 months |

### EXAMPLE 14

Using an injection-molding machine for tubular containers as in Japanese Patent Laid-Open No. 25411/1981 (Japanese Patent Publication No. 7850/1989), low-density polyethylene (LDPE, Mitsui Petrochemical's Ultzex 3520L) was injection-molded into a head of a tubular container. In this process where the low-density polyethylene was fed into the injection-molding machine, a cylindrical tube to be a body of the container, which had been prepared previously, was fed into the mold of the machine.

The injection-molding machine used herein is a 35 mmφ in-line screw-type injection-molding machine. In this, the head of the tubular container was molded at a cylinder temperature of 240° C. and at a nozzle temperature of 235° C. The tubular container produced herein had an outer diameter of 35 mmφ, and the squeeze mouth of its head had an outer diameter of 12 mmφ and an inner diameter of 7 mmφ. The thickness of the head was 2 mm. The cylindrical tube had a structure of low-density polyethylene (LDPE, Mitsui Petrochemical's Ultzex 3520L; thickness 150μ)/adhesive resin (Mitsui Petrochemical's Admer NF500; thickness 20μ)/EVOH (having an ethylene content of 32 mol %, a degree of saponification of 99.5%, and MFR of 1.6 g/10 min (at 190° C. under a load of 2160 g); thickness 20μ)/adhesive resin (Mitsui Petrochemical's Admer NF500, thickness 20μ)/LDPE (Mitsui Petrochemical's Ultzex 3520L; thickness 150μ), and this was produced by co-extrusion through a ring die.

The head of the two-piece tubular container produced in the manner as above was sprayed with a powder of a barrier material (b-1) that had been powdered in the same manner as in Example 1, according to a flame spray coating process. The thickness of the barrier layer was 50 μm. The tubular container of which the head was coated with the barrier material (b-1) was tested for the storability of its contents.

(8) Storability of Contents:

Miso (seasoned soybean paste) was filled into the tubular container of which the head was coated with the barrier material (b-1), through the opening at its bottom, and the opening was heat-sealed. Next, a piece of aluminium foil (thickness 25μ) was fitted to only the squeeze mouth of its head, and the head was capped. The tubular container filled with miso was kept in a thermo-hygrostat at 40° C. and 50% RH.

After thus kept therein for 24 hours, the tubular container was taken out. The Miso kept in contact with the inner surface of the head of the container was macroscopically checked as to whether or not it was discolored. According to the criteria A to D mentioned below, the content storability of the container was evaluated, and it was on the rank A.
A: Not discolored.
B: Discolored in pale brown.
C: Discolored in brown.
D: Discolored in reddish brown.

### COMPARATIVE EXAMPLE 5

A tubular container was produced and tested in the same manner as in Example 14. In this, however, the head of the tubular container was not coated with the barrier material (b-1). The content storability of the tubular container produced herein was on the rank D.

Effect of the Invention

According to the method of producing shaped articles of the invention, it is possible to coat a polyolefin substrate of a complicated shape with a barrier material, not requiring any complicated primer treatment. For example, the invention provides multi-layered shaped articles comprising a polyolefin and a barrier material, and gasoline permeation through the articles is effectively retarded. In particular, according to the invention, even complicated shapes can be easily processed to make them have barrier properties. Accordingly, the shaped articles of the invention are favorable to components for fuel containers, fuel tanks for automobiles, fuel pipes, etc.

1. A method of producing a shaped article, which comprises applying a powder of a barrier material (B), after melting it, to a substrate of a polyolefin (A).

2. The method of producing a shaped article as claimed in claim 1, wherein the step of applying a powder of a barrier material (B), after melting it, to the substrate is effected according to a flame spray coating process.

3. The method of producing a shaped article as claimed in claim 1, which comprises applying a powder of a carboxylic acid-modified or boronic acid-modified polyolefin, after melting it, to a substrate of a polyolefin (A), followed by applying a powdery coating substance of a barrier material (B), after melting it, to the resulting carboxylic acid-modified or boronic acid-modified polyolefin layer.

4. The method of producing a shaped article as claimed in claim 1, which comprises applying a powder of a barrier material (B), after melting it, to a substrate of a polyolefin (A), followed by applying a powder of a thermoplastic resin (C) having an elastic modulus at 20° C. of at most 500 kg/cm², after melting it, to the resulting layer of the barrier material (B).

5. A method of producing a shaped article, which comprises applying a powder of a thermoplastic resin (C) having an elastic modulus at 20° C. of at most 500 kg/cm², after melting it, to a substrate of a polyolefin (A), followed by applying a powder of a barrier material (B), after melting it, to the resulting layer of the thermoplastic resin (C).

6. The method of producing a shaped article as claimed in claim 1, wherein the polyolefin (A) is a high-density polyethylene.

7. The method of producing a shaped article as claimed in claim 1, wherein the barrier material (B) is at least one selected from a group consisting of ethylene-vinyl alcohol copolymers, polyamides, aliphatic polyketones and polyesters.

8. The method of producing a shaped article as claimed in claim 1, wherein the barrier material (B) is a resin composition comprising from 50 to 95% by weight of an ethylene-vinyl alcohol copolymer and from 5 to 50% by weight of a boronic acid-modified polyolefin.

9. The method of producing a shaped article as claimed in claim 1, wherein the barrier material (B) is a resin composition comprising from 50 to 95% by weight of an ethylene-vinyl alcohol copolymer and from 5 to 50% by weight of multi-layered polymer particles.

10-21. (canceled)
